(19) United States
(12) Patent Application Publication
(10) Pub. No.: US 2016/0217174 A1
(43) Pub. Date: Jul. 28, 2016

(54) DATABASE SYSTEM

(71) Applicant: Kabushiki Kaisha Toshiba, Tokyo (JP)

(72) Inventors: Kenji Takahashi, Kawasaki Kanagawa (JP); Yoshiei Sato, Ota Tokyo (JP); Takahiro Kurita, Sagamihara Kanagawa (JP); Mototaka Kanematsu, Yokohama Kanagawa (JP)

(21) Appl. No.: 14/755,940

(22) Filed: Jun. 30, 2015

Related U.S. Application Data
(60) Provisional application No. 62/108,235, filed on Jan. 27, 2015.

(51) Int. Cl. G06F 17/30

(52) U.S. Cl. CPC G06F 17/30371; G06F 17/30185; G06F 17/30362

(57) ABSTRACT

According to one embodiment, there is provided a database system in which a database server and a storage are connected via a communication line. The storage includes a data area, a transaction information storage area, a journal log storage area, and a first circuit. The database server includes a second circuit. The second circuit writes transaction information into the transaction information storage area determined from a combination of the subject database server and a unit of division of processing executing transaction processing.

### CROSS-REFERENCE TO RELATED APPLICATIONS

This application is based upon and claims the benefit of priority from U.S. Provisional Application No. 62/108,235, filed on Jan. 27, 2015; the entire contents of which are incorporated herein by reference.

### FIELD

Embodiments described herein relate generally to a database system.

### BACKGROUND

A conventional database system includes a database client, a database server, a storage, and a transaction management server. In the conventional system, the one transaction management server intensively executes processing for maintaining consistency of data to be stored in the storage. Therefore, a processing load concentrates on the transaction management server, and even if an increased number of database servers is used, the transaction management server causes a bottleneck. As a result, it is difficult to achieve performance improvement in the configuration of the conventional database system.

### BRIEF DESCRIPTION OF THE DRAWINGS

FIG. 1 is a schematic block diagram of an example of a database system according to a first embodiment;

FIG. 2 is a schematic block diagram of a functional configuration of a transaction management unit;

FIG. 3 is a schematic diagram illustrating transition of data writing state;

FIG. 4 is a diagram illustrating an example of a log saved in transaction processing;

FIGS. 5A and 5B are diagrams illustrating examples of a transaction log and a journal log according to the first embodiment;

FIG. 6 is a flowchart of an example of a data control process in the database system according to the first embodiment;

FIG. 7 is a flowchart of an example of a boot process at power-on of the database system according to the first embodiment;

FIG. 8 is a flowchart of an example of a rollforward process according to the first embodiment;

FIG. 9 is a flowchart of an example of a rollback process according to the first embodiment;

FIG. 10 is a schematic block diagram of an example of a database system according to a second embodiment;

FIG. 11 is a schematic diagram of an example of a data storage state according to the second embodiment;

FIG. 12 is a flowchart of an example of a data control process in the database system according to the second embodiment;

FIG. 13 is a flowchart of an example of a rollforward process according to the second embodiment;

FIG. 14 is a flowchart of an example of a rollback process according to the second embodiment;

FIG. 15 is a schematic diagram of an example of a database system according to a third embodiment;

FIG. 16 is a schematic block diagram of an example of a connection module according to the third embodiment;

FIG. 17 is a diagram of an example of an NM;

FIG. 18 is a diagram for describing a packet;

FIGS. 19A to 19D are diagrams illustrating examples of methods for saving a journal log according to the third embodiment;

FIG. 20 is a schematic diagram of an example of a configuration for building a RAID in a storage unit;

FIG. 21 is a schematic block diagram of an example of a database system according to a fourth embodiment;

FIG. 22 is a schematic block diagram of an example of a functional configuration of a transaction management unit according to the fourth embodiment;

FIG. 23 is a diagram illustrating an example of divisions in a transaction information storage unit according to the fourth embodiment;

FIGS. 24A and 24B are diagrams illustrating examples of contents of transaction information according to the fourth embodiment;

FIG. 25 is a diagram illustrating an example of a journal log;

FIG. 26 is a flowchart of an example of a data control process in the database system according to the fourth embodiment;

FIG. 27 is a flowchart of an example of a boot process at power-on of the database system according to the fourth embodiment;

FIG. 28 is a schematic block diagram of another example of the database system according to the fourth embodiment;

FIG. 29 is a schematic block diagram of another example of the database system according to the fourth embodiment; and

FIG. 30 is a schematic block diagram of an example of a general database system.

### DETAILED DESCRIPTION

In general, according to one embodiment, there is provided a database system in which a database server and a storage are connected via a communication line. The database server executes processing based on a data control request. The storage includes a data area, a transaction information storage area, a journal log storage area, and a first circuit. The data area stores a database. The transaction information storage area stores transaction information including a start log or an end log for transaction processing. The journal log storage area stores a journal log including writing state of the data to the storage based on the data control request. The first circuit manages lock state and the writing state of target data in the storage, and records the journal log in the journal log storage area. The database server includes a second circuit. Upon receipt of the data control request, the second circuit determines the transaction information storage area from a combination of the subject database server and a unit of division of processing executing the transaction processing. The second circuit also writes the transaction information into the determined transaction information storage area.

Exemplary embodiments of a database system will be explained below in detail with reference to the accompanying drawings. The present invention is not limited to the following embodiments.

### First Embodiment

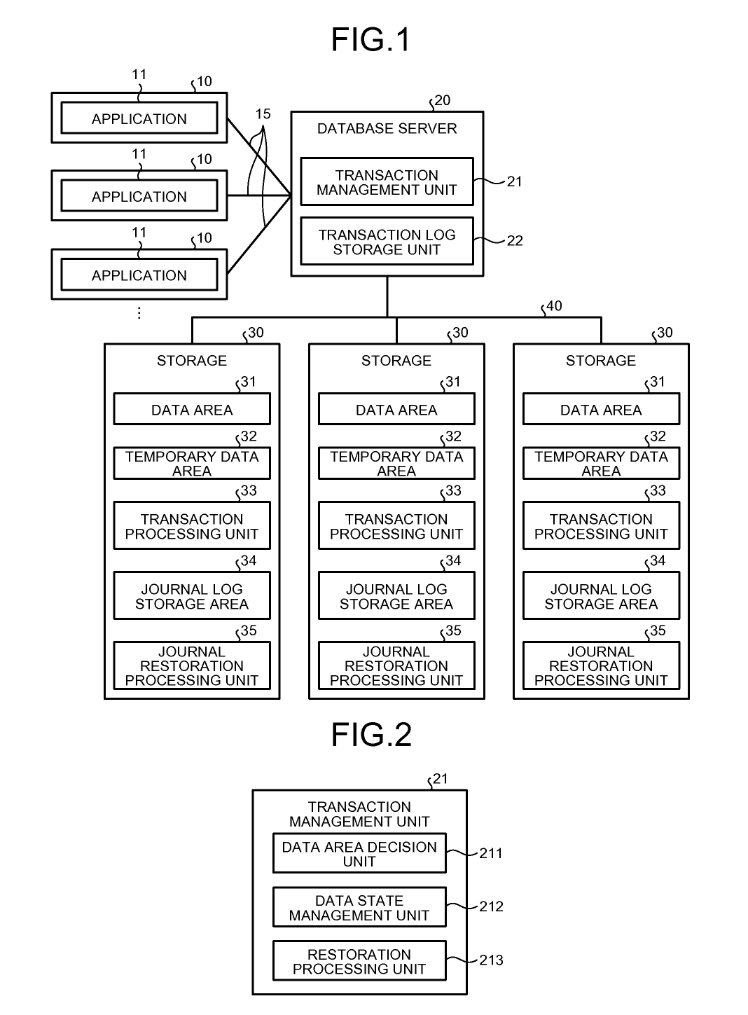

FIG. 1 is a schematic block diagram of an example of a database system according to a first embodiment. The database system includes a database client 10, a database server 20, and a storage 30.

The database client 10 is an information processing device such as a personal computer. The database client 10 contains an application 11 with a user interface for accessing a database to perform an operation. Specifically, the application 11 has the function of accepting a control request from the user and transmitting a data control request to the database server 20. The data control request is intended to make a request for data reading, writing, updating, or deletion, for example.

The database client 10 is connected to the database server 20 via a network 15. The network 15 may be Ethernet, for example. A plurality of database clients 10 may be connected to the database server 20. In this example, the database client 10 is illustrated as an information processing device containing the application 11 for control of the database. Alternatively, the database client 10 may be composed of another device or a program having the foregoing function.

The database server 20 is an information processing device on which middleware is executed to provide transaction management and database access. In the embodiment, the database server 20 includes a transaction management unit 21 and a transaction log storage unit 22. The transaction management unit 21 manages transactions and transfers data or logs to each of the storages 30. The transaction management unit 21 may be configured by such as a circuit or a hardware processor. The transaction log storage unit 22 may be configured by storage. FIG. 2 is a schematic block diagram of a functional configuration of the transaction management unit. The transaction management unit 21 includes a data area decision unit 211, a data state management unit 212, and a restoration processing unit 213.

The data area decision unit 211 decides one or more data areas in which data as a target of writing, updating or deletion (hereinafter, referred to as operation target) is saved. In the case of a key-value database, the data control request from the database client 10 includes a key. The data area decision unit 211 performs a predetermined hashing operation on the key and uses the operation result to decide the data area of the operation target, that is, the address of the operation target. The data area corresponds to a record in the database.

The data state management unit 212 manages the state of data as an operation target in transaction processing. Specifically, at the start of the transaction processing, the data state management unit 212 issues a lock request for the data (record) as a target of the transaction processing, and at the end of the transaction processing, the data state management unit 212 issues an unlock request for the data (record) as the target of the transaction processing. In the locked state, the data cannot be accessed from another database client 10 (application 11). The data state management unit 212 also requests the storage 30 for transition of the writing state of the data during the transaction processing, or records a log for a predetermined operation in the transaction processing as a transaction log.

In the event of power-off in the course of the transaction processing, the restoration processing unit 213 executes a restoration process for the database. Specifically, on boot of the database system, the restoration processing unit 213 determines whether power-off has occurred in the course of the transaction processing. When determining that power-off has occurred in the course of the transaction processing, the restoration processing unit 213 executes the restoration process for the database using the transaction logs and the journal logs in the storage 30.

The transaction log storage unit 22 stores predetermined logs saved at the database server 20 side in the transaction processing, as transaction logs.

The storage 30 is a memory device that stores data and journal logs in the database in a non-volatile manner. The storage 30 has a data area 31, a temporary data area 32, a transaction processing unit 33, a journal log storage area 34, and a journal restoration processing unit 35. The storage 30 is connected to the database server 20 via a network 40. The network 40 may be Ethernet, for example.

The data area 31 is an area for storing a database, management information, and the like. The management information includes address information indicating the position of data stored in the data area 31.

The temporary data area 32 is an area into which writing data or updating data is temporarily written for writing or updating at the database in the transaction processing.

The transaction processing unit 33 executes transaction processing based on a request from the database server 20. Specifically, upon receipt of a lock request or an unlock request from the database server 20, the transaction processing unit 33 locks or unlocks data as an operation target (hereinafter, referred to as target data). The transaction processing unit 33 also causes transition of the writing state of the target data based on a transition request of writing state of data in the transaction processing from the database server 20. At that time, the transaction processing unit 33 records a log for a pre-specified operation as a journal log.

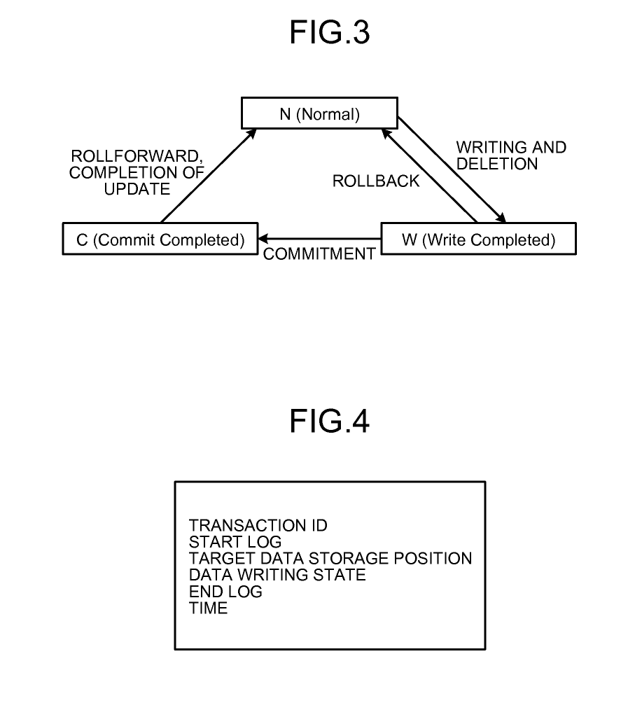

Transition of the writing state in the database system will be described. FIG. 3 is a schematic diagram illustrating transition of data writing state. The writing state includes three phases: Normal (N state), Write Completed (W state), and Commit Completed (C state). The data is generally in the N state. When writing, updating, or deletion is requested, a transition of the data state to the W state (Write Completed state) occurs. At that time, the old processed data remains in the data area 31 and the new data is written into the temporary data area 32.

When a rollback request is made in the W state, the new data in the temporary data area 32 is discarded. Meanwhile, when a commitment request is made in the W state, a transition of the data state to the C state occurs. At that time, in the storage 30, the data from the temporary data area 32 is written into the data area 31. When the storage 30 has a logical-physical address conversion table for conversion between logical addresses and physical addresses, the addresses of the data are exchanged between the data area 31 and the temporary data area 32 in the logical-physical address conversion table.

When the data is unlocked in the C state, a transition of the data state to the N state occurs. At that time, the data saved in the temporary data area 32 is invalidated or deleted so that only the data in the data area 31 is validated. In addition, the same process is executed when a rollforward request is made in the C state.

The journal log storage area 34 stores pre-decided journal logs saved at the storage 30 side in the transaction processing. In the embodiment, the logs recorded in the transaction processing are shared between the database server 20 and the storage 30.

The data area 31, the temporary data area 32, and the journal log storage area 34 are composed of non-volatile memory such as NAND-type flash memory and magnetic discs.

FIG. 4 is a diagram illustrating an example of a log saved in transaction processing. The log includes a transaction ID, a start log, target data storage position, data writing state, an end log, time, and others. The transaction ID is an identifier for uniquely identifying the transaction processing. The start log is a log indicative of start of the transaction. The start log in the embodiment indicates at least start of the transaction processing. The target data storage position refers to the storage position of the target data. The data writing state indicates which of the W state, the C state, and the N state in FIG. 2, for example. Any change in the data writing state is recorded in the log. The W state is recorded when a request for writing, updating, or deletion is issued. The C state is recorded when a commitment request is issued. The writing state in the embodiment indicates at least writing of data into the temporary data area 32 or writing of data from the temporary data area 32 into the data area 31. The end log is a log indicative of end of the transaction processing. The end log in the embodiment indicates at least end of the transaction processing. The time refers to the time at which the transaction processing was executed.

As described above, in the embodiment, there are provided the transaction log as first log to be recorded at the database server 20 side and the journal log as second log to be recorded at the storage 30 side. The transaction log and the journal log are selected from among the logs described in FIG. 4. The transaction log and the journal log in the embodiment hold at least information for maintaining consistency in the database at re-boot of the database system after improper power-off. It does not matter which of the contents is saved in which of the journals as far as the transaction log and the journal log complement each other in contents. The transaction log and the journal log are associated with each other.

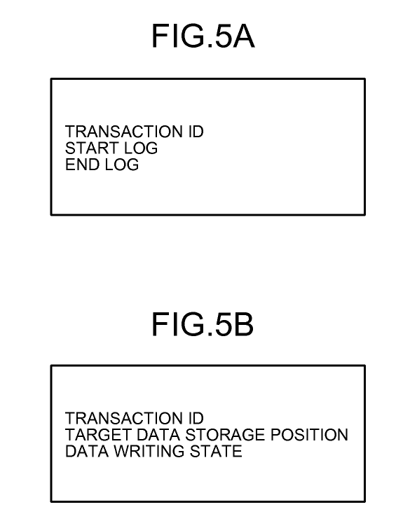

FIGS. 5A and 5B are diagrams illustrating examples of a transaction log and a journal log according to the first embodiment. The transaction ID, the start log, and the end log may be recorded as the transaction log as illustrated in FIG. 5A, and the transaction ID, the target data storage position, and the data writing state may be recorded as the journal log as illustrated in FIG. 5B.

In the example of FIG. 5B, the journal log includes the transaction ID. Alternatively, the journal log may be more simplified as far as the transaction log and the journal log can be connected together. For example, when the target data storage position is to be recorded in the transaction log, the journal log does not need the transaction ID. This is because it is possible to determine which data is the target of the journal log since the target data storage position is recorded in the transaction log, and in the database, the data is unlocked at the time of operation of the data so that the target data can be operated only by one application 11.

FIGS. 5A and 5B illustrate mere examples, and any contents may be recorded in each of the transaction log and the journal log. However, it is desirable to select the contents to be recorded in the transaction log and the journal log so as not to put a load on the database server 20 in the log recording process. The transaction log and the journal log may be recorded in text format or in binary format. FIG. 5A illustrates the case where the end log is recorded in the transaction log. Alternatively, instead of recording the end log illustrated in FIG. 5A, the transaction log and the journal log may be erased.

The journal restoration processing unit 35 uses the journal log in the journal log storage area 34 to execute a database restoration process based on instructions from the restoration processing unit 213 of the database server 20. The transaction processing unit 33 and the journal restoration processing unit 35 may be configured by such as a circuit or a hardware processor.

In the embodiment, all of the storages 30 are configured to have the data area 31, the temporary data area 32, and the journal log storage area 34. This eliminates the need to provide a dedicated log storage as described above in relation to the background art.

Next, operations of the thus configured database system will be described. First, a data control process will be described, and then a boot process at power-on will be described.

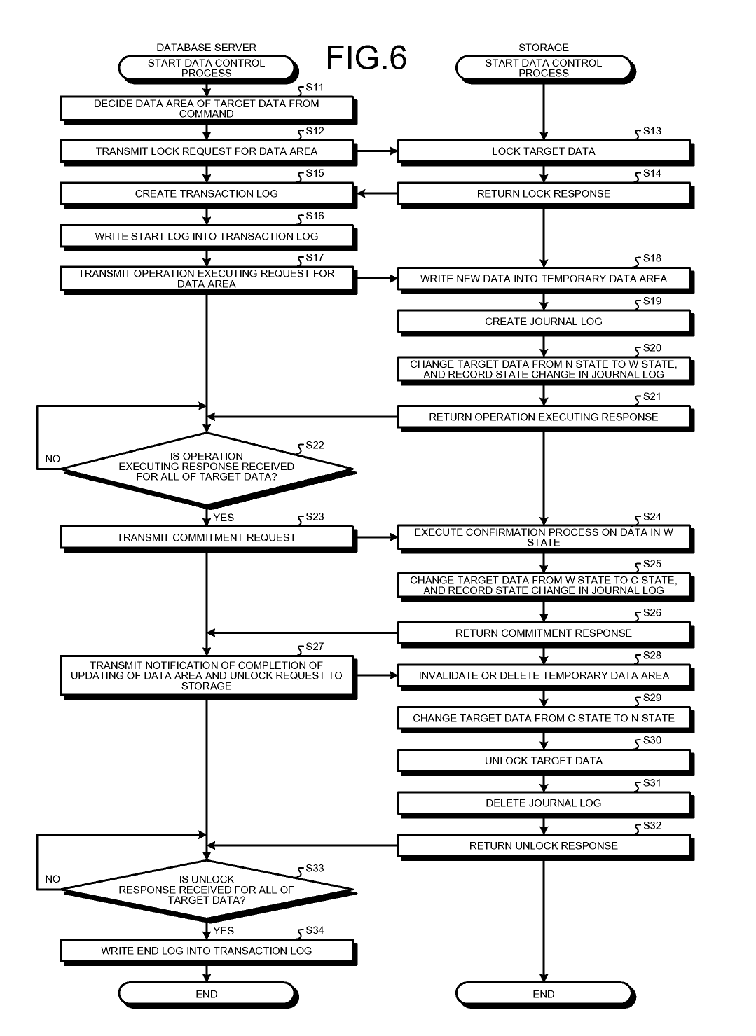

FIG. 6 is a flowchart of an example of a data control process in the database system according to the first embodiment. FIG. 6 represents operations of the database server 20 and the storage 30. First, the user transmits a command (data control request) for writing, updating, or deletion of data (record) from the database client 10 to the database server 20.

The data area decision unit 211 of the database server 20 decides a data area in which the target data is stored from the received command (step S11). One transaction processing handles one or more data areas. The data state management unit 212 then transmits a lock request for the data area decided at step S11 to each of the storages 30 (step S12).

Upon receipt of the lock request from the database server 20, the transaction processing unit 33 of the storage 30 turns on the locked state of the target data (step S13). In the locked state in the embodiment, it can be indicated at least whether the data to be written or updated is capable of being written or updated under other instructions from the database server 20. After that, the transaction processing unit 33 returns to the database server 20 a lock response indicating that the locked state of the target data to which the lock request has been made is successfully turned on (step S14).

In this example, the locked state of the target data can be turned on. However, when the target data is already locked by another application, no process for operating the data can be executed. In this case, the transaction processing unit 33 returns to the database server 20 a lock response indicating that the locked state of the target data has failed to be turned on. The database server 20 makes a response indicating that the transaction processing specified by the command has failed to the application 11 of the database client 10, whereby the process is completed.

The data state management unit 212 of the database server 20 then creates a transaction log for the transaction processing (step S15). The transaction log has the transaction ID including information for identifying the database server 20 having issued the command, for example. The data state management unit 212 also writes the start log into the transaction log (step S16). The start log includes information indicating that the transaction processing has been started, and the storage positions of all data needed to be written, updated, or deleted. The information indicative of the start of the transaction processing may use a character string such as “start,” for example.

The data state management unit 212 of the database server 20 then transmits an operation executing request for writing, updating, or deletion of data in each of the data areas to the storage 30 (step S17). To write or update data, the operation executing request includes an instruction for writing or updating, the storage position of the target data after the writing or updating, and new data to be written or used for updating. To delete data, the operation executing request includes an instruction for deletion and the storage position of the target data after the deletion. Upon receipt of the operation executing request, the transaction processing unit 33 of the storage 30 writes the target data into the temporary data area 32 (step S18).

The transaction processing unit 33 of the storage 30 creates a journal log for each of the target data (step S19). The journal log may include the transaction ID or the storage position of the target data after the writing, updating, or deletion.

Writing the target data into the temporary data area 32 changes the state of the target data from the N state to the W state. At that time, the transaction processing unit 33 records the change in the state of the target data into the journal log of the target data (step S20). That is, the transaction processing unit 33 records the transition to the W state. After that, the transaction processing unit 33 returns to the database server 20 an operation executing response indicating that the operation executing request is fulfilled (step S21). The operation executing response includes information indicating that the data state is changed to the W state, for example.

The data state management unit 212 of the database server 20 then determines whether the operation executing response indicating that the data is in the W state has been received for all of the target data in the transaction processing (step S22). When all of the target data is not in the W state (step S22: No), the data state management unit 212 waits until all of the target data is in the W state. Meanwhile, when all of the target data is in the W state (step S22: Yes), the data state management unit 212 transmits a commitment request for the target data to the storage 30 (step S23).

Upon receipt of the commitment request, the transaction processing unit 33 of the storage 30 executes a confirmation process for the data in the W state (step S24). Specifically, the transaction processing unit 33 replaces the target data in the data area 31 with the new data written into the temporary data area 32. By one method, the target data in the database is replaced with the new data in the temporary data area 32. By another method, the address of the target data in the database and the address of the new data in the temporary data area 32 are exchanged in the logical-physical conversion table. In this case, the temporary data area 32 after the exchange stores the target data having been stored before in the database.

Upon completion of the confirmation process for the data, the transaction processing unit 33 of the storage 30 changes the W state to the C state, and records the change in the state of the target data in the journal log (step S25). That is, the transaction processing unit 33 records the transition to the C state. After that, the transaction processing unit 33 returns a commitment response to the commitment request (step S26).

The data state management unit 212 of the database server 20 then makes a notification of completion of updating each of the data areas and an unlock request to each of the storages 30 (step S27). Upon receipt of the notification of completion of updating and the unlock request, the transaction processing unit 33 of the storage 30 invalidates or deletes the temporary data area 32 (step S28). For example, when the target data in the database is replaced with the new data in the temporary data area 32 at step S24, the data in the temporary data area 32 is deleted. When the address of the target data in the database and the address of the data in the temporary data area 32 are exchanged in the logical-physical address conversion table, the address indicative of the temporary data area 32 is invalidated after the exchange.

The transaction processing unit 33 also updates the state of the target data from the C state to the N state (step S29) and unlocks the target data (step S30). During the unlock process, the transaction processing unit 33 deletes the created journal log (step S31). After that, the transaction processing unit 33 returns an unlock response to the unlock request to the database server 20 (step S32).

After that, the data state management unit 212 of the database server 20 determines whether the unlock response is received for all of the target data (step S33). When no unlock response is received for all of the target data (step S33: No), the data state management unit 212 enters the waiting state. When the unlock response is received for all of the target data (step S33: Yes), the data state management unit 212 recognizes that the operation process is completed, and writes the end log into the transaction log with the corresponding transaction ID (step S34), whereby the process is completed.

After the end of the foregoing transaction processing, the power is generally turned off. Thus, the database is updated before the power-off based on a request from the application 11. However, a power failure or the like may occur before unlocking to disable normal power-off of the database system. In such cases, the transaction processing is interrupted at some midpoint in the foregoing flowchart. When the transaction processing is thus discontinued, a rollback process or a rollforward process is executed to maintain data consistency at the next boot. Then, the boot process at power-on will be described.

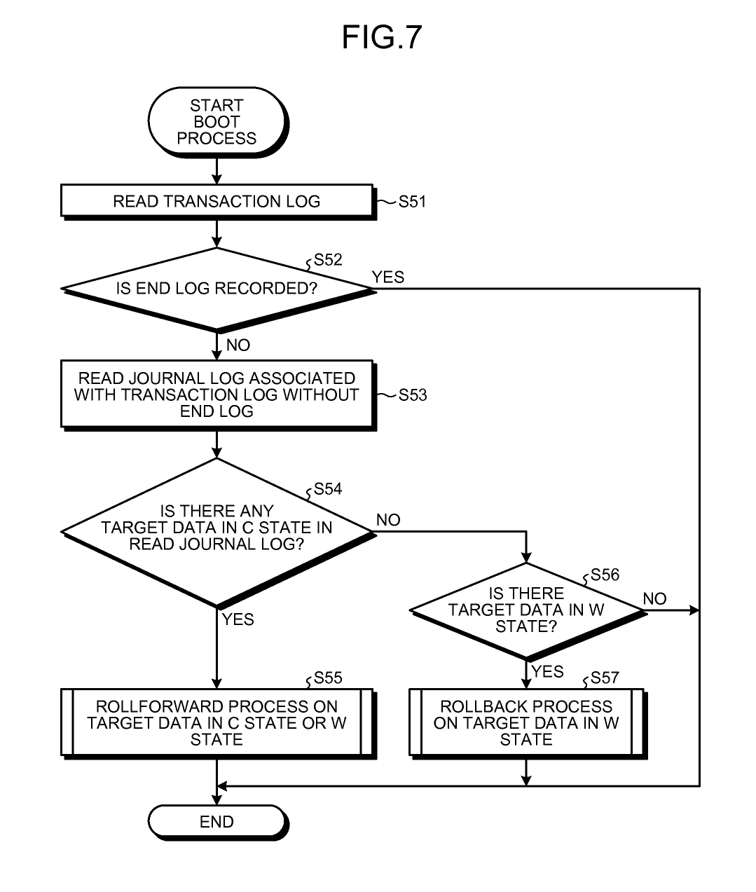

FIG. 7 is a flowchart of an example of a boot process at power-on of the database system according to the first embodiment. First, the restoration processing unit 213 of the database server 20 reads the transaction log from the transaction log storage unit 22 (step S51), and determines whether the end log is recorded in the transaction log (step S52). When the end log is recorded (step S52: Yes), this means that the previous power-off was a normal end with data consistency maintained in the database. Thus, no process for maintaining data consistency in the database is executed, whereby the process is completed.

Meanwhile, when no end log is recorded (step S52: No), the restoration processing unit 213 determines that the previous power-off is an abnormal end with data consistency not maintained in the database, which requires the process for maintaining data consistency in the database (hereinafter, referred to as restoration process). The restoration processing unit 213 of the database server 20 reads the journal log associated with the transaction log with no end log from the storage 30 (step S53).

Upon receipt of an instruction for reading the journal log, the transaction processing unit 33 of the storage 30 acquires the corresponding journal log from the journal log storage area 34, and transmits the journal log to the database server 20. At that time, when the journal log records the transaction ID to the journal log, for example, the storage 30 searches for the journal log with the same transaction ID as that included in the reading instruction, and acquires the journal log. When the journal log has no transaction ID but has the storage position of the target data, the storage 30 can acquire the journal log by making an inquiry to another storage 30 managing the storage position of the target data.

Then, the restoration processing unit 213 determines whether any target data in the C state exists in the read journal log (step S54). When there exists any target data in the C state (step S54: Yes), this means that all of the target data included in the transaction processing has been completely written. Accordingly, the restoration processing unit 213 executes the rollforward process on the target data in the C state or the W state (step S55), whereby the boot process is completed.

When there exists any target data in the C state in the read journal log, this means that the temporary data area 32 has not been deleted or invalidated. When there exists any target data in the W state, this means that the new data to be written has been stored in the temporary data area 32. When there exists any target data in the C state, this means that the new data to be written or old data before the writing has been stored in the temporary data area 32. The rollforward process is intended to move the target data to the state after writing or the state after updating based on the foregoing data state. Details of the rollforward process will be described below.

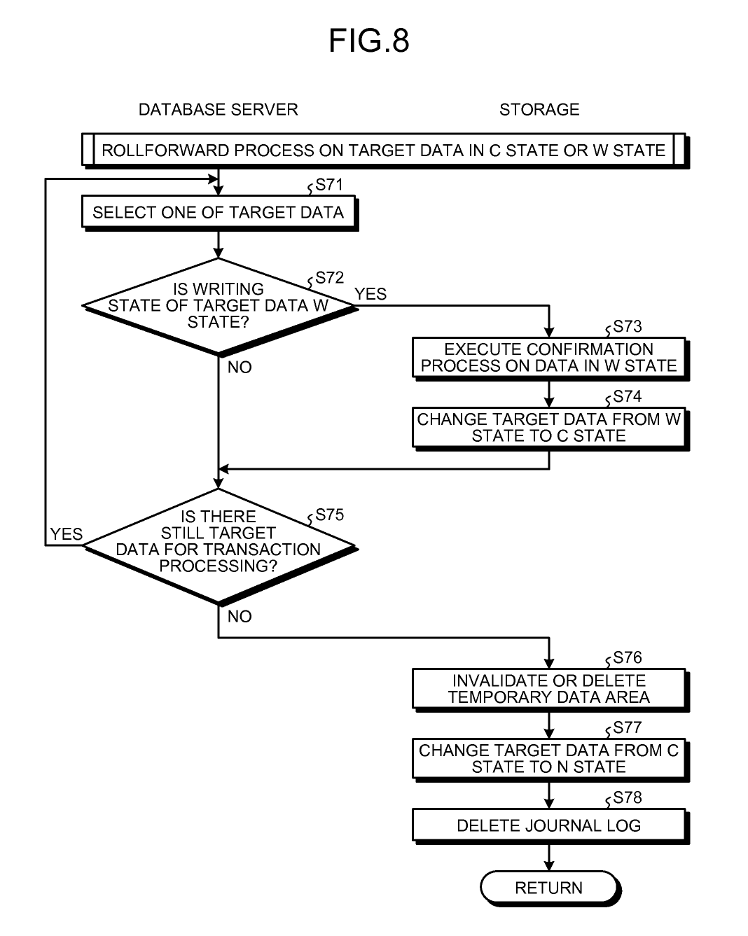

FIG. 8 is a flowchart of an example of the rollforward process according to the first embodiment. The restoration processing unit 213 of the database server 20 selects one of the target data (step S71). Then, the restoration processing unit 213 of the database server 20 determines whether the last writing state of the target data in the journal log is the W state (step S72). The journal log records data writing states in chronological order, and the latest record indicates the last writing state.

When the target data is in the W state (S72: Yes), the journal restoration processing unit 35 of the storage 30 executes a confirmation process for the data in the W state (step S73). Specifically, the journal restoration processing unit 35 executes the same process as that at step S24 described above with reference to the flowchart in FIG. 6. The journal restoration processing unit 35 of the storage 30 then changes the state of the target data from the W state to the C state (step S74).

Meanwhile, when the target data is not in the W state (step S72: No), that is, when the target data is in the C state, this means that the data saved in the temporary data area 32 has undergone the commitment process. The commitment in the embodiment is realized at least by saving the target data in all of the transaction processing in the temporary data area 32, and then writing the target data into the data area 31. Therefore, no process is executed. After that or after step S74, the restoration processing unit 213 of the database server 20 determines whether there still remains target data to be processed in the transaction processing (step S75). When there still remains any target data to be processed (step S75: Yes), the process is returned to step S71. Meanwhile, when there remains no target data (step S75: No), the journal restoration processing unit 35 of the storage 30 deletes or invalidates the temporary data area 32 corresponding to the target data (step S76). After that, the journal restoration processing unit 35 of the storage 30 changes the state of the target data from the C state to the N state (step S77), and deletes the journal log (step S78). Then, the process is returned to the step in FIG. 7.

Meanwhile, when there exists no target data in the C state at step S54 (step S54: No), this means that all of the target data included in the transaction processing has not been completely written. Thus, the restoration processing unit 213 of the database server 20 further determines whether there exists target data in the W state (step S56). When there exists no target data in the W state (step S56: No), this means that no new data has been written into the temporary data area 32, and it is not necessary to execute the process for maintaining data consistency. After that, the boot process is completed.

When there exists any target data in the W state (step S56: Yes), this means that some of the target data has been completely written into the temporary data area 32 but the other has not been completely written into the temporary data area 32. The restoration processing unit 213 thus executes the rollback process (step S57), whereby the boot process is completed.

When there exists any data in the W state in the read journal log, this means that the new data has been written into the temporary data area 32. Meanwhile, when there exists no data in the W state, that is, there exists any data in the N state, this means that no new data has been written into the temporary data area 32. The rollback process is intended to return the target data to the state before the writing or the state before the updating based on the foregoing data state. Details of the rollback process will be described below.

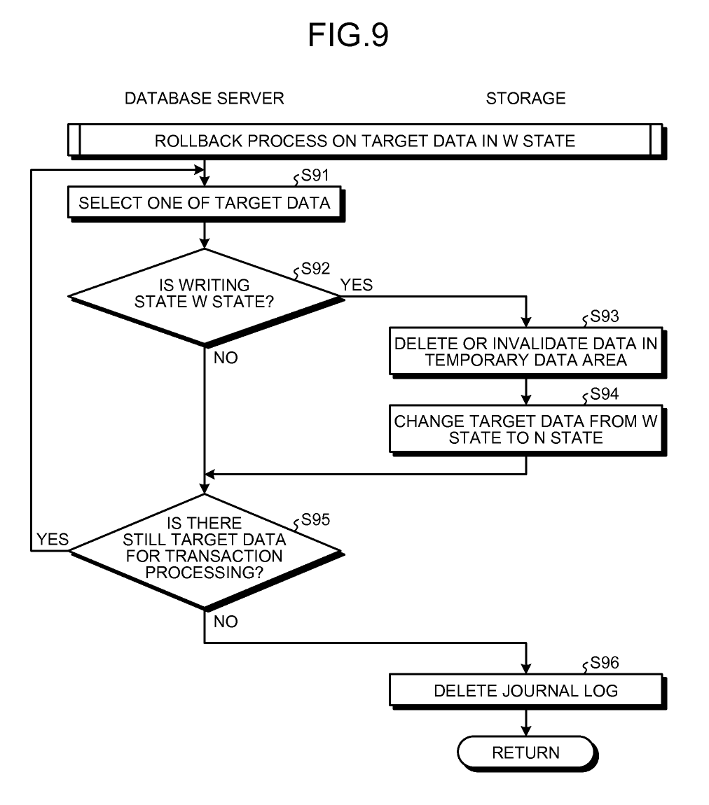

FIG. 9 is a flowchart of an example of the rollback process according to the first embodiment. The restoration processing unit 213 of the database server 20 selects one of the target data (step S91), and determines whether the last writing state of the journal log corresponding to the target data is the W state (step S92).

When the writing state is the W state (step S92: Yes), the journal restoration processing unit 35 of the storage 30 deletes or invalidates the data in the temporary data area 32 (step S93), and changes the data state of the target data from the W state to the N state (step S94). That is, the journal restoration processing unit 35 uses the original data stored in the database. Meanwhile, when the data state is not the W state (step S92: No), the journal restoration processing unit 35 does not execute any process.

After that or after step S94, the restoration processing unit 213 of the database server 20 determines whether there still remains target data to be processed in the transaction processing (step S95). When there still remains any target data (step S95: Yes), the process is returned to step S91. When there remains no target data (step S95: No), the journal restoration processing unit 35 of the storage 30 deletes the journal log (step S96). Then, the process is returned to the steps in FIG. 7.

At the foregoing steps S31, S78, and S96, the journal log is deleted. Alternatively, the journal log may not be deleted from the journal log storage area 34 of the storage 30 but information indicating that the transaction processing for the target data is completed may be recorded in the journal log.

In the foregoing description, the restoration processing unit 213 exists in the database server 20 and the journal restoration processing unit 35 exists in the storage 30. However, the embodiment is not limited to this example but the functionality of the restoration processing unit 213 of the database server 20 and the functionality of the journal restoration processing unit 35 of the storage 30 may exist in either of the database server 20 or the storage 30.

As described above, in the first embodiment, the log management of the transaction processing executed by the database server 20 in a general database system is shared between the database server 20 and the storage 30. Specifically, the records in the database server 20 are set as a transaction log and the records in the storage 30 are set as a journal log, and at the time of occurrence of a pre-decided event, the event is recorded in the journal log at the storage 30. This allows the storage 30 to bear part of a burden of log creation on the database server 20.

Also in a general database system, it is necessary to transfer the logs created at the database server 20 to the storage 30. In the first embodiment, however, logs are recorded spontaneously at the storage 30 and there is no need to transfer the logs from the database server 20 to the storage 30. It is possible to reduce a burden on the database server 20 in the process of creating logs.

Further, in a general database system, when an increased number of storages 30 is used, the database server 20 is intensively accessed to keep logs, and the logs are transferred to the dedicated log storage to impose a burden on the interface. In the first embodiment, however, even though an increased number of storages 30 is used, each of the storages 30 records a journal log, which provides the advantage that there is no intensive access to the database server 20 or no burden imposed on the interface.

### Second Embodiment

In the first embodiment, data to be written is temporarily saved in the temporary data area, and then the data in the temporary data area is set as data in the data area in the commitment process. In a second embodiment, there is provided no temporary data area.

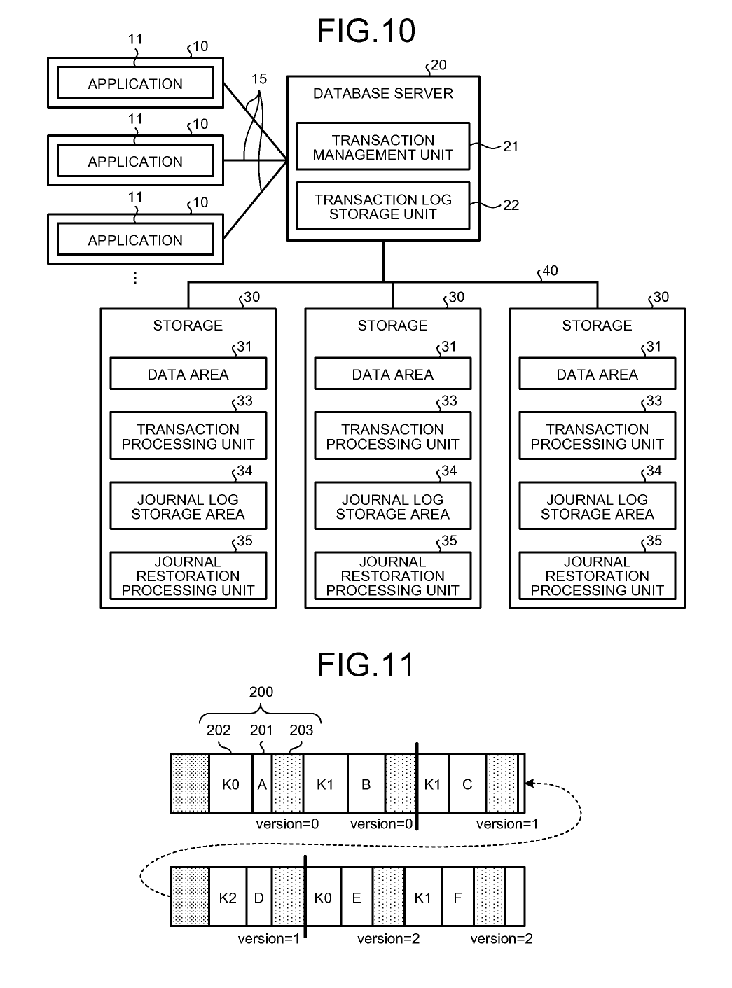

FIG. 10 is a schematic block diagram of an example of a database system according to the second embodiment. Unlike in the first embodiment, the storage 30 is not provided with the temporary data area 32 in the second embodiment. When the rollback process is executed in the W state, the journal restoration processing unit 35 of the storage 30 sets a bit indicating that the version is invalid (hereinafter, referred to as version invalidity flag) in the metadata of the data. When the data state is changed from the C state to the N state, or when the rollforward process is executed in the C state, the transaction processing unit 33 and the journal restoration processing unit 35 delete the transaction logs of the target data. The metadata in the embodiment indicates at least an old-and-new relationship in data updates. In addition, the version invalidity flag in the embodiment indicates at least whether the data with the metadata is invalid. The same constitutional elements in the second embodiment as those in the first embodiment will be given the same reference numerals as those in the first embodiment, and descriptions thereof will be omitted.

FIG. 11 is a schematic diagram of an example of a data storage state according to the second embodiment. In the second embodiment, the data area 31 stores data 200 including data 201, a key 202 with unique identification information for the data 201, and metadata 203 for the data 201. The metadata 203 is given a version number indicative of an old-and-new relationship (version) in updates of the data. The data 200 is written into the end of a data group in a sector to be updated of the data area 31. Sectors may be coupled as illustrated in FIG. 11. Referring to FIG. 11, metadata for data “A” with a key of “K0” records “version=0,” and metadata for data “B” with a key of “K1” records “version=0.” In addition, metadata for data “C” with a key of “K1” records “version=1,” and metadata for data “D” with a key of “K2” records “version=1.” Further, metadata for data “E” with a key of “K0” records “version=2,” and metadata for data “F” with a key of “K1” records “version=2.”

The data writing state in this case will be described with reference to FIG. 3. According to this method, when writing, updating, or deletion of data is requested in the N state, the data state is changed to the W state (write completed state). At that time, new data is written into the end of the data group in the target sector of the data area 31. The metadata includes the version number of the written data.

When a rollback request is made in the W state, a version invalidity flag is set in the metadata for the written data. When a data reading request is made, the data of the version with the invalidity flag is passed through without being read. That is, the process is continued until the version without the version invalidity flag is found.

Meanwhile, when a commitment request is made in the W state, the data state is changed to the C state. At that time, no operation is performed on the data in the data area 31 but the transition to the C state is recorded in the journal log.

When the data is unlocked in the C state, the data state is changed to the N state. At that time, the journal log for the target sector is deleted. When a rollforward request is made in the C state, the same process is executed.

Data is read with reference to the version invalidity flags and the journal logs. Specifically, the data of the version with the version invalidity flag is not read. In addition, for the data of the version with no version invalidity flag, data with the latest version number is acquired. When the data writing state is not the W state, the data with the latest version number is returned. Meanwhile, when the data writing state is the W state, data with the next new version number is returned because the data in the W state is yet to be confirmed.

In the example of FIG. 11, the data of version=2 is written into the data area 31 but the data is yet to be subjected to the commitment process. In addition, all of the data with the earlier version numbers have no version invalidity flag. In this case, the data “E” and “F” are in the state before data confirmation (before transition to the C state), and the corresponding journal log records “W state.” In this state, when acquisition of the data with the key of “K2” is requested, for example, the data of version=2 has no “K2” and thus the data “D” of version=1 preceding the data of version=2 is read. In addition, when acquisition of the data with the key of “K0” is requested, for example, the data “A” of version=0 preceding the data of version=2 is read.

Meanwhile, in the example of FIG. 11, the data of version=2 has undergone the commitment process. In this case, the data “E” and “F” are in the state after data confirmation (after transition to the C state), and the corresponding journal log records “C state.” In this state, when acquisition of the data with the key of “K2” is requested, for example, the data of version=2 has no “K2” and the data “D” of version=1 preceding the data of version=2 is read. In addition, when acquisition of the data with the key of “K0” is requested, for example, the data “E” of version=2 is read.

When there is no journal log because there is no new data or the data is already unlocked, this means that all of the data has been confirmed, and thus the data of the version at the beginning of the target sector is read.

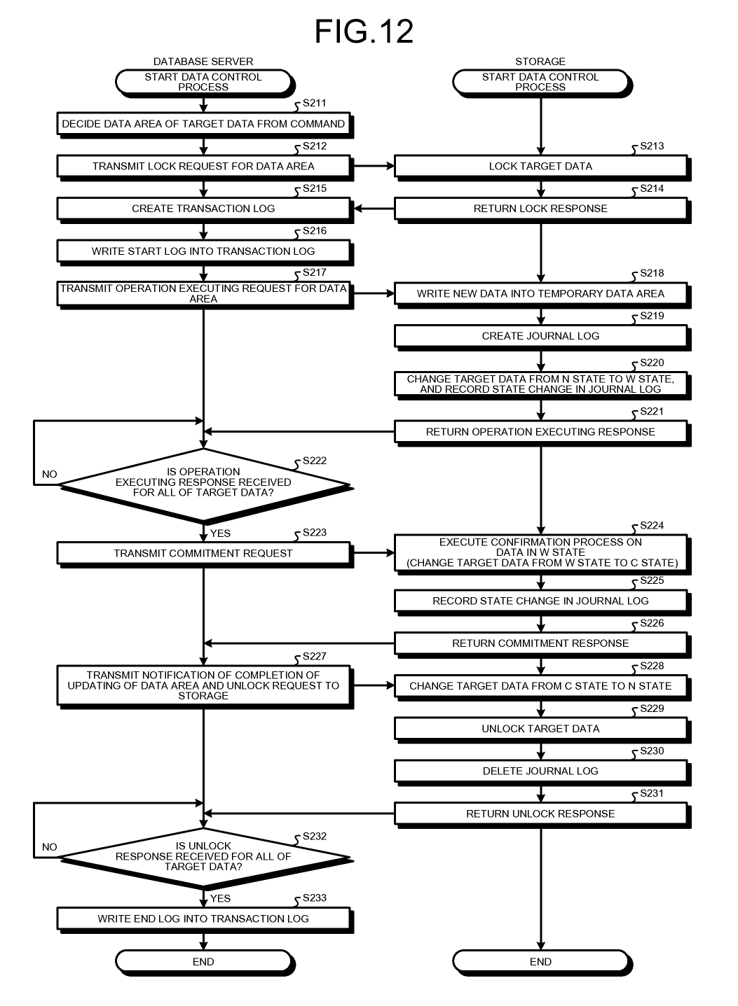

Next, operations of the thus configured database system will be described. FIG. 12 is a flowchart of an example of a data control process in the database system according to the second embodiment. FIG. 12 indicates operations of the database server 20 and the storage 30. First, the same steps as steps S11 to S17 of FIG. 6 in the first embodiment are carried out. Specifically, upon receipt of a command (data control request) for an operation of writing, updating, or deletion of data (record), the database server 20 determines a data area in which the target data is stored from the received command, and transmits a lock request to each of the storages 30. The storage 30 turns on the lock state of the target data, and returns a lock response to the database server 20. The database server 20 then creates a transaction log for the transaction processing, writes a start log into the transaction log, and transmits an operation executing request for writing, updating, or deletion in the data area to each of the storages 30 (steps S211 to S217).

Upon receipt of the request for performing an operation, the transaction processing unit 33 of the storage 30 writes temporarily the target data (step S218). At that time, the transaction processing unit 33 adds metadata and a version number to the end of a data group in the target sector. The target data is written temporarily into the data area 31, for example.

After that, the same steps as steps S19 to S21 of FIG. 6 are carried out. Specifically, the storage 30 creates a journal log for each of the target data, records the change in the state of the data to the W state in the journal log for the target data, and returns an operation executing response to the database server 20. Upon receipt of the operation executing response indicating that all of the target data in the transaction processing is changed into the W state, the database server 20 transmits a commitment request for each of the target data to each of the storages 30 (steps S219 to S223).

Upon receipt of the commitment request, the transaction processing unit 33 of the storage 30 executes a confirmation process on the data in the W state (step S224). In this example, the transaction processing unit 33 changes the written data from the W state to the C state. After the data confirmation process, the transaction processing unit 33 of the storage 30 records the change in the state of the target data in the journal log (step S225). That is, the transaction processing unit 33 records that the target data is in the C state. After that, the transaction processing unit 33 returns a commitment response to the commitment request (step S226).

Then, the data state management unit 212 of the database server 20 makes a notification of the end of the updating of the data areas and makes an unlock request to each of the storages 30 (step S227). After that, the same steps as steps S29 to S34 of FIG. 6 are carried out. The storage 30 updates the state of the target data from the C state to the N state to unlock the target data, and deletes the journal log. After that, the storage 30 returns an unlock response to the database server 20. Upon receipt of the unlock response for all of the target data, the database server 20 writes an end log into the transaction log (steps S228 to S233), whereby the process is completed.

The steps of the boot process at power-on of the database system is the same as described in FIG. 7 in relation to the first embodiment. Therefore, descriptions thereof will be omitted, and the rollforward process and the rollback process will be described. However, when the determination result is negative at step S56, this means that no data has been newly written. Meanwhile, when the determination result is affirmative at step S56, this means that some of the target data has been completely written into the target sector in the data area 31, but the other has not been completely written into the data area 31.

When there exists any target data in the C state in the journal log read at step S55 of FIG. 7, this means that the temporarily written data has not been deleted or invalidated. When there exists any data in the W state in the journal log, this means that the newly written data has been stored. When there exists any data in the C state in the journal log, this means that the temporary data before confirmation or the old data before writing has been stored. The rollforward process is intended to turn the target data into the state after writing or the state before updating based on the data state. Details of the rollforward process will be described below.

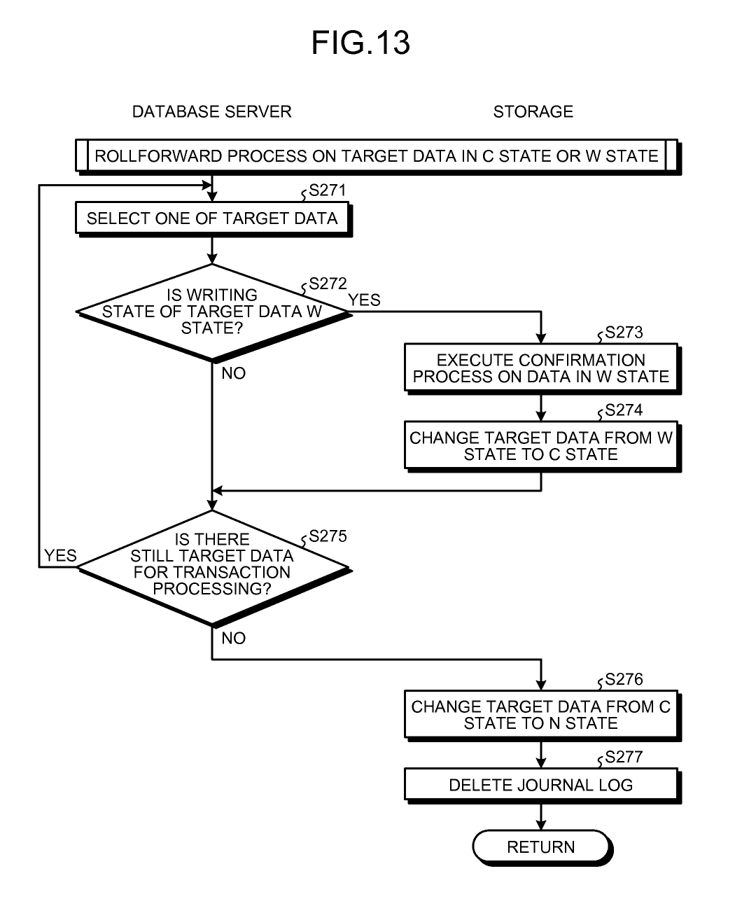

FIG. 13 is a flowchart of an example of the rollforward process according to the second embodiment. The restoration processing unit 213 of the database server 20 selects one of the target data (step S271). The restoration processing unit 213 of the database server 20 then determines whether the last writing state of the journal log for the target data is the W state (step S272). The journal log is overwritten when the target sectors are the same in the transaction.

When the writing state is the W state (step S272: Yes), the journal restoration processing unit 35 of the storage 30 executes a confirmation process on the data in the W state (step S273). Specifically, the journal restoration processing unit 35 performs the same step as step S224 in the flowchart of FIG. 6. The journal restoration processing unit 35 of the storage 30 then changes the state of the target data from the W state to the C state (step S274).

Meanwhile, when the writing state is not the W state (step S272: No), that is, when the writing state is the C state, this means that the temporarily written data has undergone a commitment process. Thus, no process is executed. After that or after step S274, the restoration processing unit 213 of the database server 20 determines whether there still remains any target data to be processed in the transaction processing (step S275). When there still remains any target data to be processed in the transaction processing (step S275: Yes), the process is returned to step S271. When there still remains no target data (step S275: No), the journal restoration processing unit 35 of the storage 30 changes the state of the target data from the C state to the N state (step S276), and deletes the journal log (step S277). Then, the process is returned to the steps in FIG. 7.

When there exists any data in the W state in the journal log read at step S57 of FIG. 7, this means that the new data has been written into the data area 31. When there exists no data in the W state, that is, when there exists data in the N state, this indicates that no new data has been written into the data area 31. The rollback process is intended to return the target data to the state before writing or the state before updating based on the data state. Details of the rollback process will be described below.

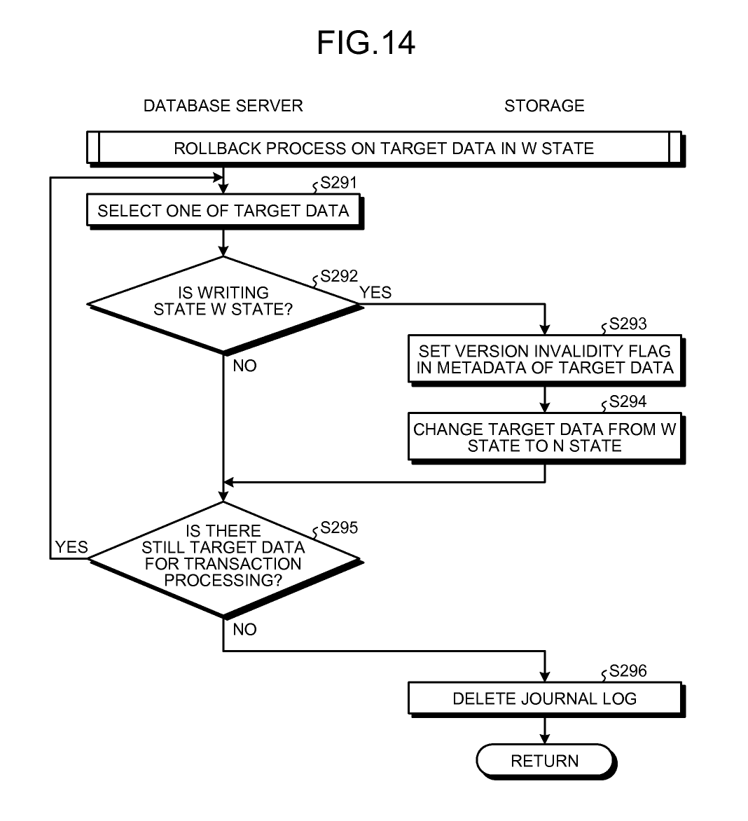

FIG. 14 is a flowchart of an example of the rollback process according to the second embodiment. The restoration processing unit 213 of the database server 20 selects one of the target data (step S291), and determines whether the last writing state in the journal log corresponding to the target data is the W state (step S292).

When the writing state is the W state (step S292: Yes), the journal restoration processing unit 35 of the storage 30 sets a version invalidity flag indicating that the version is invalid in the metadata for the target data in the data area 31 (step S293), and changes the data state of the target data from the W state to the N state (step S294). That is, the original data saved in the database is used as it is. Meanwhile, when the writing state is not the W state (step S292: No), no process is executed.

After that or after step S294, the restoration processing unit 213 of the database server 20 determines whether there still remains any target data to be processed in the transaction processing (step S295). When there still remains any target data (step S295: Yes), the process is returned to step S291. When there remains no target data (step S295: No), the journal restoration processing unit 35 of the storage 30 deletes the journal log (step S296). Then, the process is returned to the steps in FIG. 7.

According to the second embodiment, the same advantages as those in the first embodiment can be obtained.

### Third Embodiment

In the first embodiment, the database server is connected to the storages in a one-to-many relationship. In a third embodiment, a plurality of database servers is connected to a plurality of memory nodes coupled in a mesh pattern.

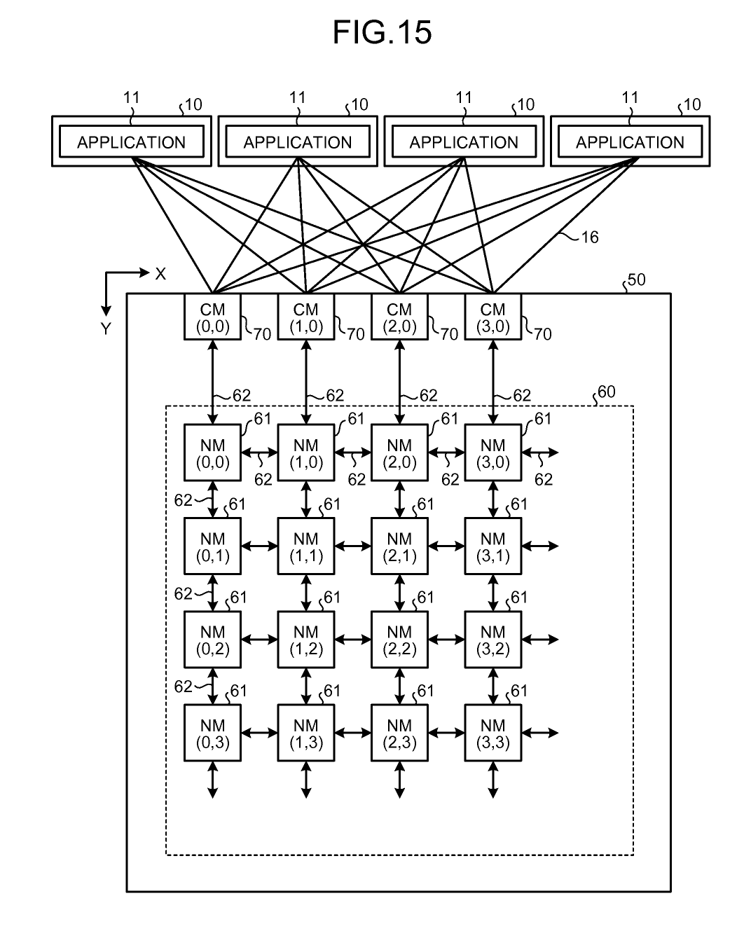

FIG. 15 is a schematic diagram of an example of a database system according to the third embodiment. The database system includes database clients 10 and a server storage unit 50. The database clients 10 and the server storage unit 50 are connected together via a network 16 such as a LAN (Local Area Network), a WAN (Wide Area Network), and the Internet. As an example, user terminals and the server storage unit 50 are connected together via Ethernet.

The server storage unit 50 includes a storage unit 60 and connection modules (hereinafter, referred to as CMs) 70. The storage unit 60 may be configured by storage. The CM 70 may be configured by such as a circuit or a hardware processor. The CM 70 corresponds to a connection circuit. The storage unit 60 and the CMs 70 are arranged on a circuit board. The storage unit 60 and the CMs 70 are connected together via an interface such as PCIe.

The storage unit 60 includes a plurality of node modules (hereinafter, referred to as NMs) 61 with a storage function and a data transfer function connected in a mesh network. The NM 61 may be configured by such as a circuit or a hardware processor. The NM 61 corresponds to a node circuit. The storage unit 60 stores data distributed over the plurality of NMs 61. The data transfer function includes a transfer mode for each of the NMs 61 to transfer packets efficiently.

FIG. 15 represents an example of a rectangular network in which the NMs 61 are arranged at grid points. The coordinates of the grid points are indicated by coordinates (x, y), and the position information of the NMs 61 arranged at the grid points are indicated by node addresses (x_{D}, y_{D}) corresponding to the coordinates of the grid points. In the example of FIG. 15, the NM 61 at the upper left corner has a node address (0, 0) of an origin point. When each of the NMs 61 is shifted in a horizontal direction (X direction) or a vertical direction (Y direction), the node address increases or decreases by integer value.

Each of the NMs 61 includes two or more interfaces 62. Each of the NMs 61 is connected to the adjacent NMs 61 via the interfaces 62. Each of the NMs 61 is connected to the NMs 61 adjacent in two or more different directions. For example, referring to FIG. 15, the NM 61 indicated by the node address (0, 0) at the upper left corner is connected to the NM 61 adjacent in the X direction and indicated by the node address (1, 0) and the NM 61 adjacent in the Y direction which is different from the X direction and indicated by the node address (0, 1). Referring to FIG. 15, the NM 61 indicated by the node address (1, 1) is connected to the four NMs 61 adjacent in four different directions and indicated by the node addresses (1, 0), (0, 1), (2, 1), and (1, 2). Hereinafter, the NMs 61 indicated by the node addresses (x_{D}, y_{D}) may be referred to as nodes (x_{D}, y_{D}).

In the example of FIG. 15, the NMs 61 are arranged at the grid points in the rectangular grid. However, the mode of the arrangement of the NMs 61 is not limited to this example. Specifically, the shape of the grid may be rectangular, hexagonal, or the like, for example, as far as each of the NMs 61 arranged at the grid points is connected to the NMs 61 adjacent in two or more different directions. In addition, in the example of FIG. 15, the NMs 61 are arranged two-dimensionally. Alternatively, the NMs 61 may be arranged three-dimensionally. When the NMs 61 are arranged three-dimensionally, each of the NMs 61 can be specified by three values (x, y, z). When the NMs 61 are arranged two-dimensionally, the NMs 61 may be connected in a torus shape by coupling the NMs 61 on opposite sides.

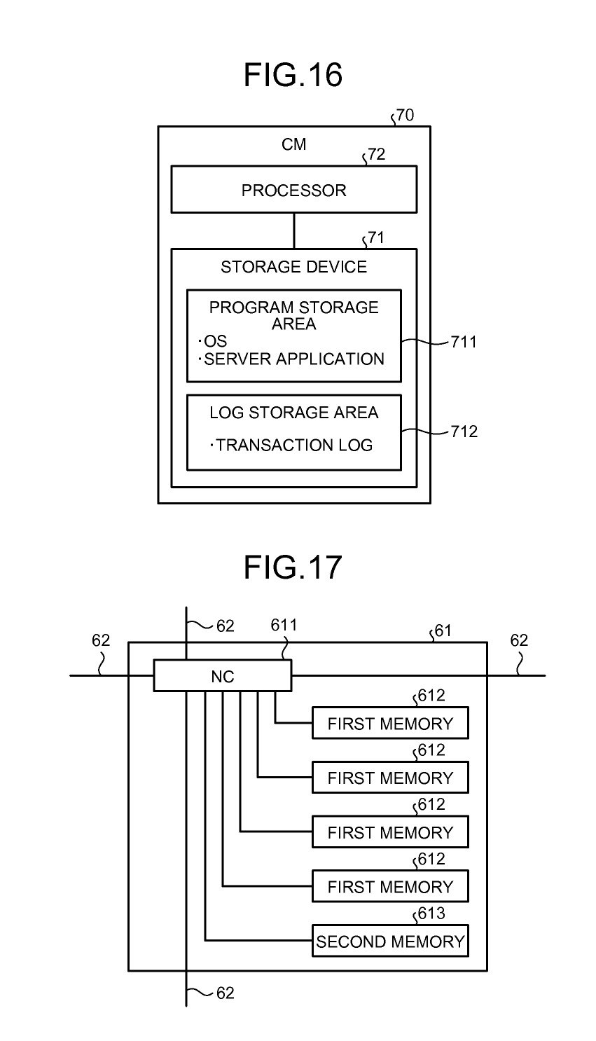

The CMs 70 include connectors connected to the outside to input or output data into or from the storage unit 60 according to requests from the outside. FIG. 16 is a schematic block diagram of an example of the CM according to the third embodiment. Each of the CMs 70 includes a storage device 71 and a processor 72. The storage device 71 has a program storage area 711 storing an operating system (hereinafter, referred to as OS) providing a file system and programs such as a server application, and a log storage area 712 storing transaction logs. The processor 72 executes the server application on the OS. Specifically, the CM 70 processes requests from the outside under control of the server application, and corresponds to the database server 20 in the first embodiment. The CM 70 makes access to the storage unit 60 in the course of the process based on requests from the outside. To make access to the storage unit 60, the CM 70 creates a packet capable of being transferred or executed by the NMs 61 and transmits the created packet to the NM 61 connected to the CM 70.

In the example of FIG. 15, the database system includes the four CMs 70. The four CMs 70 are connected to the different NMs 61. In this example, the four CMs 70 are connected on a one-to-one basis to the node (0, 0), the node (1, 0), the node (2, 0), and the node (3, 0). The number of the CMs 70 can be set freely. The CMs 70 can be connected to any NMs 61 constituting the storage unit 60. In addition, one CM 70 may be connected to a plurality of NMs 61, or one NM 61 may be connected to a plurality of CMs 70. Further, the CM 70 may be connected to any NM 61 out of the plurality of NMs 61 constituting the storage unit 60.

Each of the CMs 70 has the role of a database server, and the server application has the function of the transaction management unit 21 described above in relation to the first embodiment. The processors 72 in the CMs 70 hold different coordinate values. In the case of FIG. 15, for example, the CMs 70 connected to the node (0, 0), the node (1, 0), the node (2, 0), and the node (3, 0) have the coordinate values (0, 0), (1, 0), (2, 0), and (3, 0) that are identical to those of the connected nodes. At the occurrence of the transaction process, the data state management unit 212 in the transaction management unit 21 creates a transaction ID using the coordinate values of the CMs 70 based on a predetermined algorithm. That is, the transaction ID includes identification information for the processor 72 having issued the transaction. This makes it possible to determine which of the CMs 70 has instructed the transaction processing in the restoration process. In addition, when a key of a key-value database is entered, the data area decision unit 211 in the transaction management unit 21 executes a hashing operation to decide the address of the target data. Then, the data area decision unit 211 decides the NM 61 corresponding to the address of the target data as destination address of the packet.

FIG. 17 is a diagram of an example of an NM. The NM 61 includes a node controller (NC) 611, a plurality of first memories 612, and a second memory 613. The NM 61 corresponds to the storage 30 in the first embodiment.

The first memories 612 function as storages 30. Each of the first memories 612 is provided with the data area, the temporary data area, and the journal log storage area described above in relation to the first embodiment. The second memory 613 is used as a work area by the NC 611. The second memory 613 is shared among the plurality of first memories 612 and is divided for each of software processors existing in the NC 611.

Each of the first memories 612 may be NAND-type flash memory, Bit-Cost Scalable memory (BiCS), magnetoresistive memory (MRAM), phase-change memory (PcRAM), resistance random access memory (ReRAM), or any combination thereof. The second memory 613 may be any of various RAM. The second memory 613 may not be included in the NM 61 when the first memories 612 serve as work areas. In the example of FIG. 17, the NM 61 is provided with the plurality of first memories 612. Alternatively, the NM 61 may be provided with one first memory 612. In the example of FIG. 17, the NM 61 is provided with one second memory 613. Alternatively, the NM 61 may be provided with a plurality of second memories 613.

The NC 611 is a controller with a FPGA (Field-Programmable Gate Array) for accessing the plurality of first memories 612. The NC 611 is connected to the four interfaces 62. The NC 611 receives packets from the CMs 70 or other NMs 61 via the interfaces 62 or transmits packets to the CMs 70 or the other NMs 61 via the interfaces 62. The interfaces 62 connecting between the NMs 61 may be LVDS (Low Voltage Differential Signaling). When the destination of the received packet is its own NM 61, the NC 611 executes the process that is executed by the transaction processing unit 33 included in the storage 30 in the first embodiment. Specifically, during the transaction processing, the NC 611 accepts an instruction related to the transaction processing from the CM 70 as the database server 20, and executes a process including access to one of the first memories 612 based on the instruction. The NC 611 also returns a response to the CM 70 as necessary. The NC 611 further records a pre-decided journal log in the first memories 612. Alternatively, the NC 611 may record a pre-decided journal log in the second memory 613. In this case, at the time of shutdown of the database system, the journal log recorded in the second memory 613 is copied to the first memories 612. When the destination of the received packet is not its own NM 61, the NC 611 transfers the packet to another NM 61 connected to its own NM 61. The interface connecting between the NC 611 and the first memories 612 may be LVDS or the like.

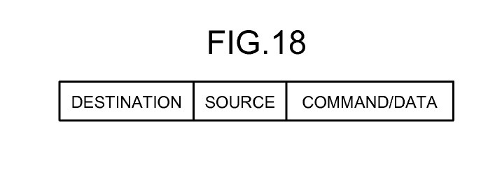

FIG. 18 is a diagram for describing a packet. The packet is composed of the node address of the destination, the node address of the source, and the command or data.

The NC 611 having received the packet decides the routing destination based on a predetermined transfer algorithm such that the packet is relayed between the NMs 61 and reaches the destination NM 61. For example, the NC 611 decides the NMs 61 on a route with the smallest number of relays between its own NM 61 and the destination NM 61, out of the plurality of NMs 61 connected to its own NMs 61, as the relaying NMs 61. When there is a plurality of routes with the smallest number of relays between its own NM 61 and the destination NM 61, the NC 611 selects one of the plurality of routes by any method. When any of the NMs 61 on the route with the smallest number of relays, out of the plurality of NMs 61 connected to its own NM 61, is defective or busy, the NC 611 decides another NM 61 as a relaying point.

Since the storage unit 60 has the plurality of NMs 61 connected in a mesh network, there is a plurality of routes with the smallest number of relays. Even though a plurality of packets addressed to a specific NM 61 is issued, the plurality of issued packets is distributed and transferred over the plurality of routes based on the foregoing transfer algorithm. This suppresses degradation of throughput in the entire database system due to intensive access to the specific NM 61.

The processes in the thus configured database system are the same as those described above in relation to the first embodiment, and description thereof will be omitted.

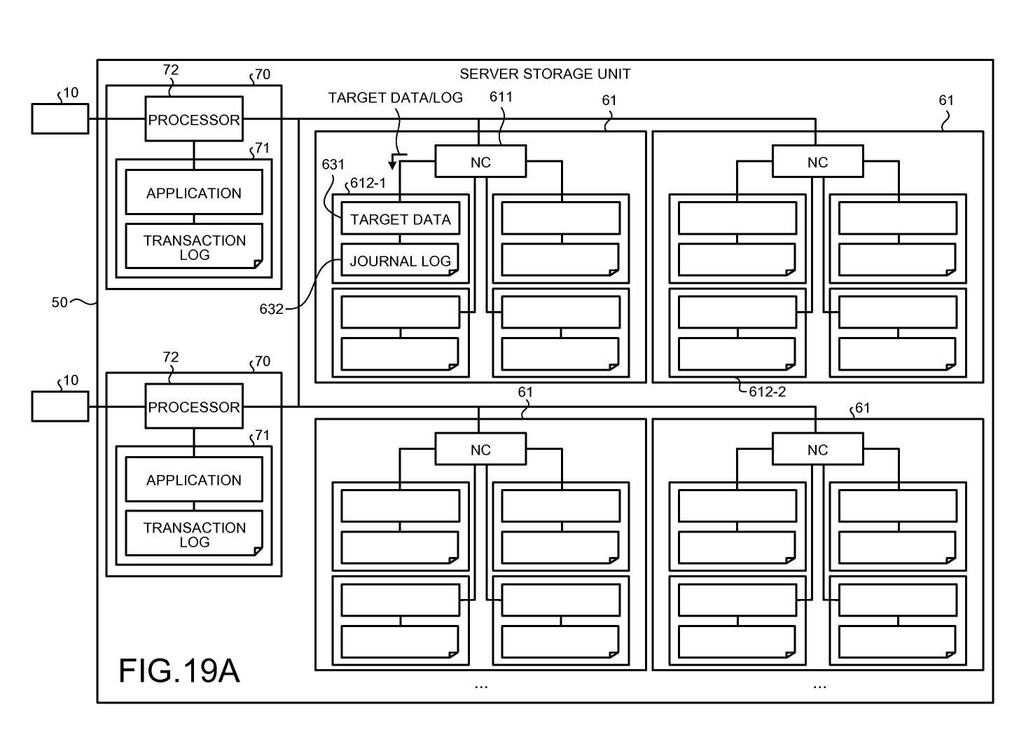

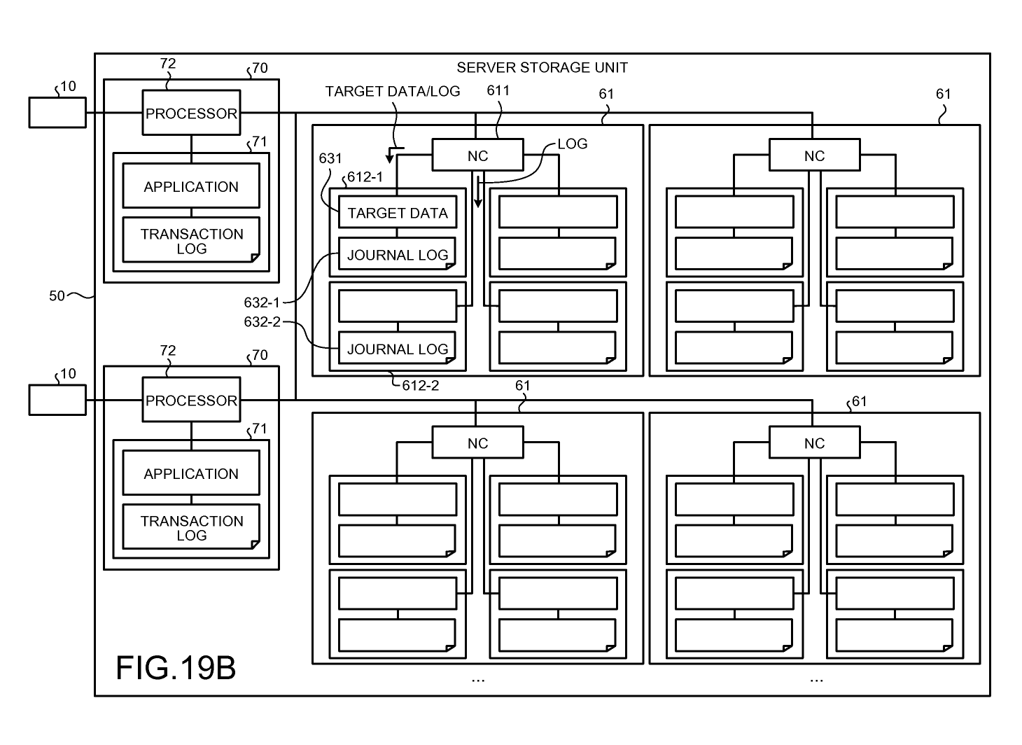

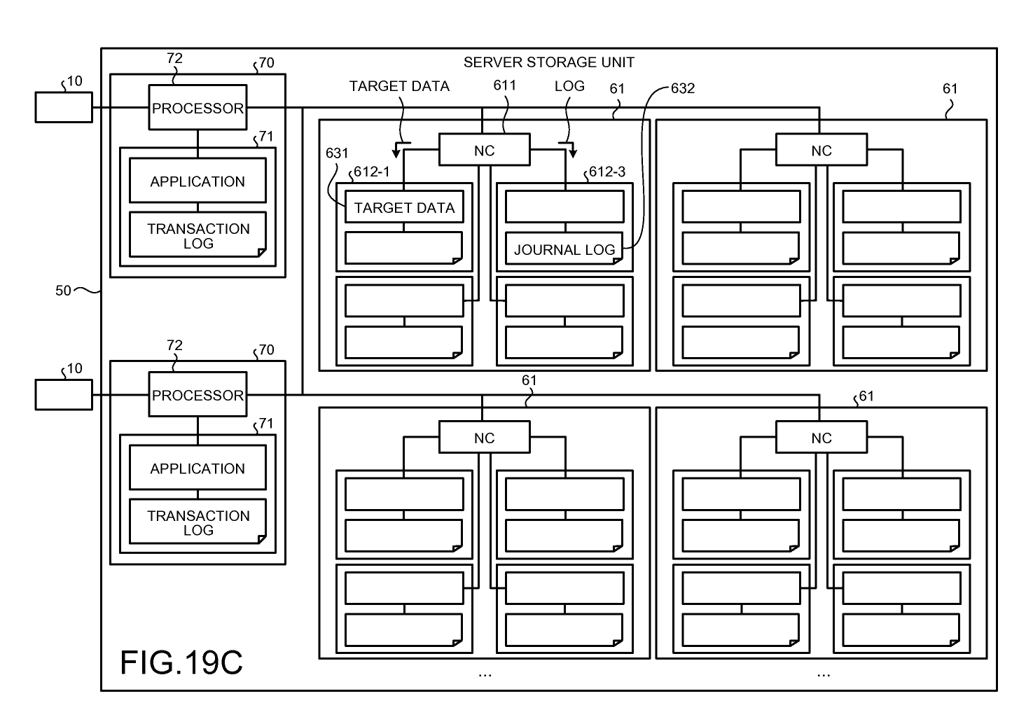

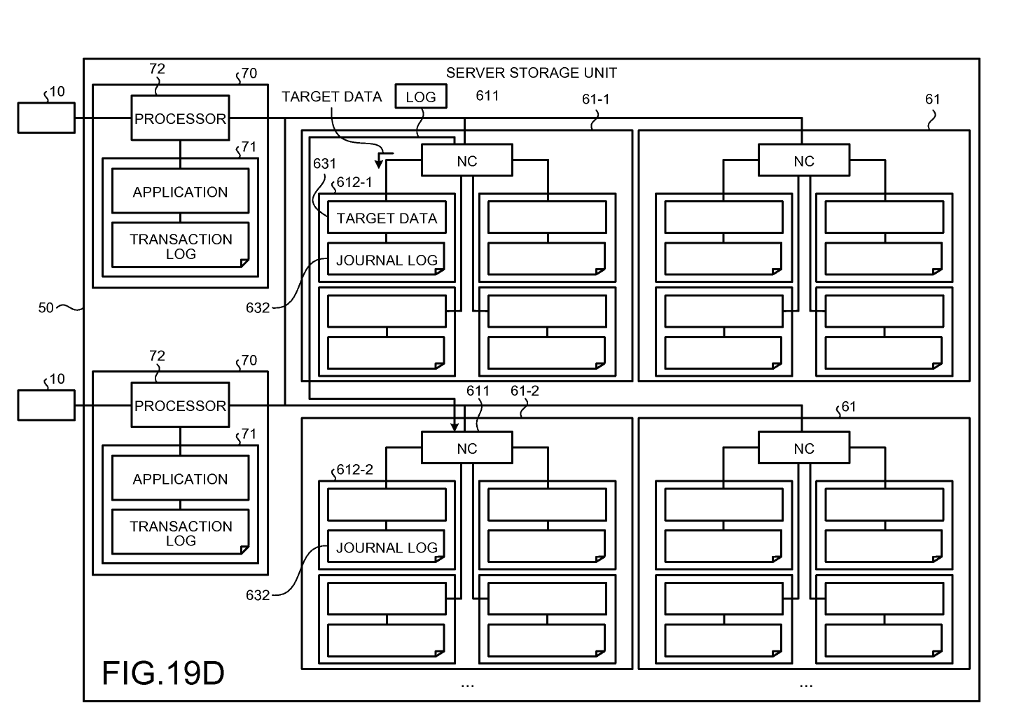

Saving of a journal log will be described. FIGS. 19A to 19D are diagrams illustrating examples of methods for saving a journal log according to the third embodiment. According to one method, the NC 611 (transaction management unit) of the NM 61 stores a journal log in a journal log storage area in the first memory 612 in which the target data is stored. As illustrated in FIG. 19A, a journal log 632 is saved in a first memory 612-1 in which target data 631 is stored in the database.

Alternatively, the NC 611 of the NM 61 may have the function of mirroring the journal log 632 into another first memory 612 in the same NM 61. In this case, as illustrated in FIG. 19B, the NC 611 records a journal log 632-1 in the first memory 612-1 in which the target data is stored, and at the same time, instructs the other first memory 612-2 in the same NM 61 as the first memory 612-1 to record a journal log 632-2. This enhances redundancy of journal logs.

According to another example of method, the NC 611 of the NM 61 may record the journal log 632 not in the journal log storage area in the first memory 612 in which the target data 631 is stored but in the journal log storage area of another first memory 612 in the same NM 61. In this case, as illustrated in FIG. 19C, the NC 611 instructs a first memory 612-3 different from the first memory 612-1 in which the target data 631 is stored to record the journal log 632.

According to still another example of method, the NC 611 of the NM 61 may record the journal log 632 in an NM 61 other than the NM 61 in which the target data 631 is stored. In this case, as illustrated in FIG. 19D, the NC 611 of an NM 61-1 transmits a packet with an instruction for recording the journal log 632 to the first memory 612-1 in which the target data 631 is stored and the first memory 612-2 of another NM 61-2 at the same time. Otherwise, two or more of the examples illustrated in FIGS. 19A to 19D may be combined.

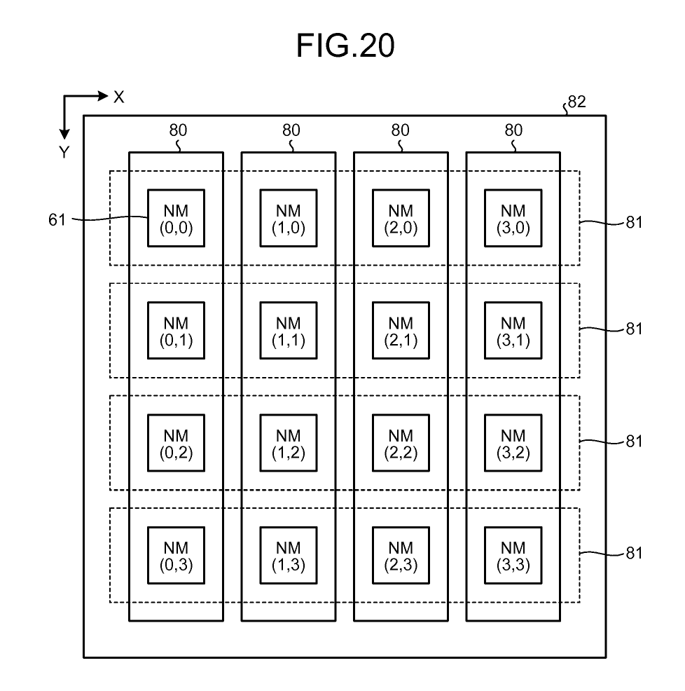

In addition, RAID (Redundant Arrays of Inexpensive Disks) may be built in the storage unit 60. FIG. 20 is a schematic diagram of an example of a configuration for building a RAID in a storage unit. The NMs 61 are mounted on card substrates 80. The four card substrates 80 are detachably attached to a backplane 82 via connectors. Each of the card substrates 80 has four NMs 61 thereon. The four each NMs 61 arranged in a Y direction are mounted on one and the same card substrate 80, and the four each NMs 61 arranged in an X direction are mounted on the different card substrates 80. Each of the NMs 61 includes the NC 611, the four first memories 612 and the second memory 613 as described above.

In the example of FIG. 20, four RAID groups 81 are built and each of the NMs 61 belongs to one of the four RAID groups 81. The four each NMs 61 mounted on the different card substrates 80 constitute one RAID group 81. In this example, the four each NMs 61 arranged in the X direction belong to one and the same RAID group 81. The applied RAID level can be set freely. For example, when a set of six disks of RAID 5 and hot spare is applied, even if one of the card substrate 80 becomes defective, it is possible to continue operation in degraded state. When RAID 6 level is applied, even if two of the NMs 61 constituting the RAID group become defective, restoration is enabled. The configurations illustrated in FIGS. 19A to 19C may be combined with the RAID illustrated in FIG. 20.

In the foregoing description, each of the NMs 61 is composed of four first memories 612. However, the embodiment is not limited to this. Each of the NMs 61 merely needs to be composed of one or more first memories 612.

According to the third embodiment, the same advantages as those in the first embodiment can be obtained.

### Fourth Embodiment

Described above in relation to the first to third embodiments are methods of recording general transaction logs separately as transaction logs in a database server and journal logs in storages. In a fourth embodiment, logs are all recorded in a storage.

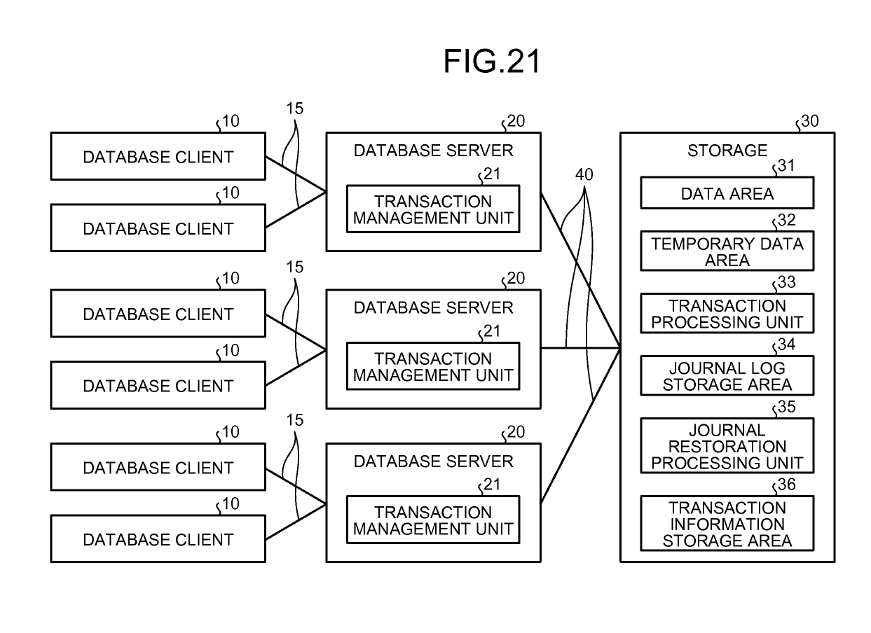

FIG. 21 is a schematic block diagram of an example of a database system according to the fourth embodiment. The database system includes database clients 10, database servers 20, and a storage 30. Unlike in the case of FIG. 1, the plurality of database servers 20 is provided.

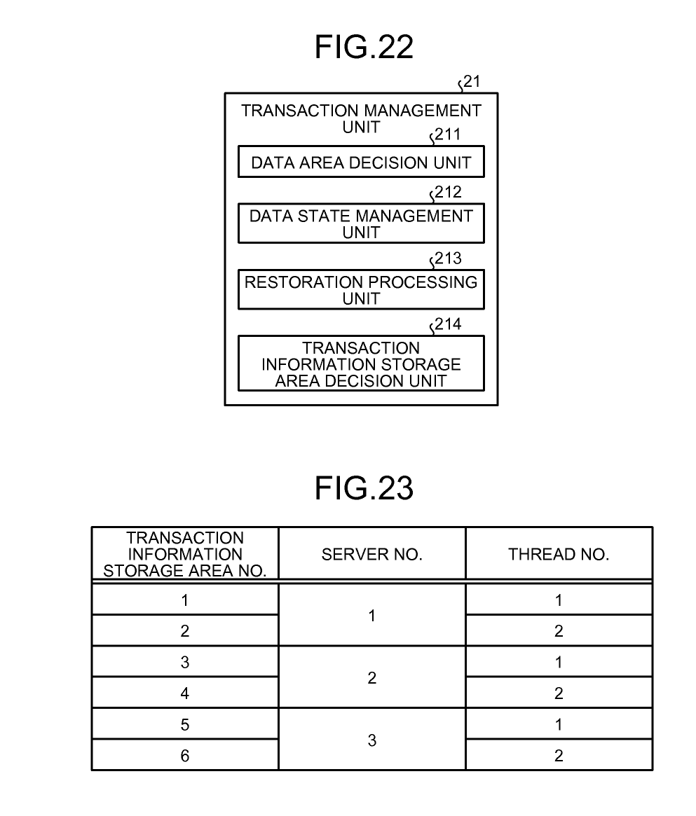

Each of the database servers 20 has a transaction management unit 21. FIG. 22 is a schematic block diagram of an example of a functional configuration of the transaction management unit according to the fourth embodiment. The transaction management unit 21 has a data area decision unit 211, a data state management unit 212, a restoration processing unit 213, and a transaction information storage area decision unit 214. At the time of execution of transaction processing, the transaction information storage area decision unit 214 decides an area in which transaction information is to be written (transaction information storage area) on the storage 30. The transaction information writing area is an area on the storage 30, which is determined by a combination of the database server 20 and a unit of division of processing by an arithmetic device of the database server 20.

FIG. 23 is a diagram illustrating an example of divisions in a transaction information storage unit according to the fourth embodiment. Referring to FIG. 23, threads are used as divisions of processing by the arithmetic device. In the this case, the number of the database servers 20 is three and the largest number of threads in each of the database servers 20 is two. As illustrated in FIG. 23, the area in which transaction information is to be written is determined by a combination of the number for the database server 20 and the number for the thread in the database server 20. For example, transaction information processed by the database server 20 with the number “1” and the thread with the number “1” is recorded in a “transaction information storage area No. 1”. Transaction information processed by the database server 20 with the number “1” and the thread with the number “2” is recorded in a “transaction information storage area No. 2”. This relationship also applies to other combinations of the database server 20 and thread.

The same constituent elements as those described above in relation to the first embodiment will be given the same reference numerals as those in the first embodiment, and descriptions thereof will be omitted. However, unlike in the first to third embodiments, the data state management unit 212 has no function of writing a transaction log into its own device. Therefore, none of the database servers 20 have the transaction log storage unit 22. In this example, each of the database servers 20 is represented as an information processing device including the transaction management unit 21. Alternatively, each of the database servers 20 may be configured as another device or a program having the foregoing function.

The storage 30 is a device that stores data. The storage 30 is composed of a hard disk drive or a non-volatile memory. The storage 30 includes a data area 31, a temporary data area 32, a transaction information storage area 36, a transaction processing unit 33, and a journal log storage area 34.

The transaction information storage area 36 records transaction information as a first log for transaction processing generated based on a data control request from the database client 10. The transaction information is equivalent to the transaction log in the first embodiment and includes a start log or an end log. The transaction information and the first log in the embodiment includes at least a start log or an end log for transaction processing. At the start of the transaction processing, the start log is overwritten in the transaction information storage area 36. At the end of the transaction processing, the end log is overwritten in the transaction information storage area 36. The transaction information storage area 36 is an area recording transaction information that is determined by an arithmetic device (database server 20) and a unit of division of processing by the arithmetic device. For example, an area for recording transaction information is specified by each of threads in each of the database servers 20. The thread here refers to a unit of division of processing by the arithmetic device. Using a plurality of threads allows a plurality of processes to be executed at the same time. The unit of division of processing by the arithmetic device may not be a thread but a process. The process in the embodiment is at least a unit of execution of a program. The thread in the embodiment is at least a unit of processing capable of parallel execution generated in a process.

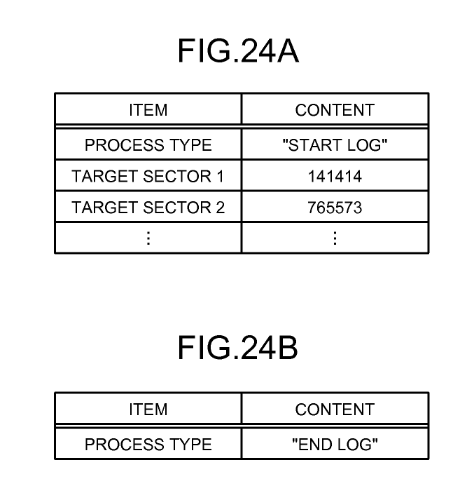

FIGS. 24A and 24B are diagrams illustrating examples of contents of transaction information in the fourth embodiment. FIG. 24A illustrates an example of a start log, and FIG. 24B illustrates an example of an end log. In the transaction information illustrated in FIG. 24A, “start log” is entered as process type, and the positions of the target data are represented by management numbers for sectors. In the transaction information illustrated in FIG. 24B, “end log” is entered as process type.

When transaction processing is executed by one unit of division of processing in one database server 20, other processing cannot be executed by the unit of division of processing. In the fourth embodiment, therefore, an area for storing one transaction information is provided for one unit of division of processing by the database server 20. The transaction information is overwritten in this area. That is, only one last written data is held in each of the divided areas illustrated in FIG. 23 for each of units of division of processing by the database server 20. Consequently, reading each of the transaction information storage areas 36 makes it possible to know to what degree which of the units of divisions of processing by which of the database servers 20 have been executed. When a plurality of storages 30 is provided, all of the storages 30 may not be provided with the transaction information storage areas 36. The transaction information storage areas 36 merely need to be provided corresponding to the number of combinations of the database servers 20 and the units of division of processing by the database servers 20. Accordingly, some of the storages 30 may be provided with the transaction information storage areas 36 and the others may not be provided with the transaction information storage areas 36.

The transaction processing unit 33 locks or unlocks target data, and changes the writing state of the target data, based on instructions from the database servers 20. Upon receipt of an instruction for writing transaction information from the database server 20, the transaction processing unit 33 writes the transaction information into the specified transaction information storage area 36. The transaction processing unit 33 also records execution of a predetermined process in the journal log storage area 34. For example, when changing the target data to the W state or the C state, the transaction processing unit 33 records the change in the journal log storage area 34.

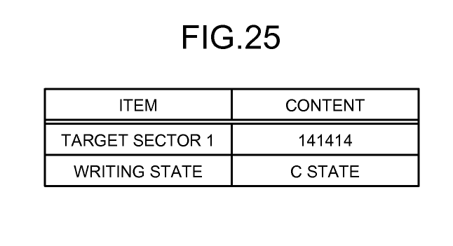

The journal log storage area 34 records a journal log as a second log for the contents of processing by the storage 30. FIG. 25 is a diagram illustrating an example of a journal log. The journal log includes the writing state of target data. The journal log storage area 34 is provided for each target data, for example. In the case of a target sector “141414” in FIG. 24A, for example, a first area in the storage 30 is assigned as the journal log storage area 34. In the case of a target sector “765573,” a second area in the storage 30 is assigned as the journal log storage area 34. The journal log and the second log in the embodiment indicate at least whether the writing state of target data is the W state or the C state.

The same constituent elements as those described above in relation to the first embodiment will be given the same reference numerals as those in the first embodiment, and descriptions thereof will be omitted.

Next, transaction processing in the thus configured database system and a boot process will be described in sequence.

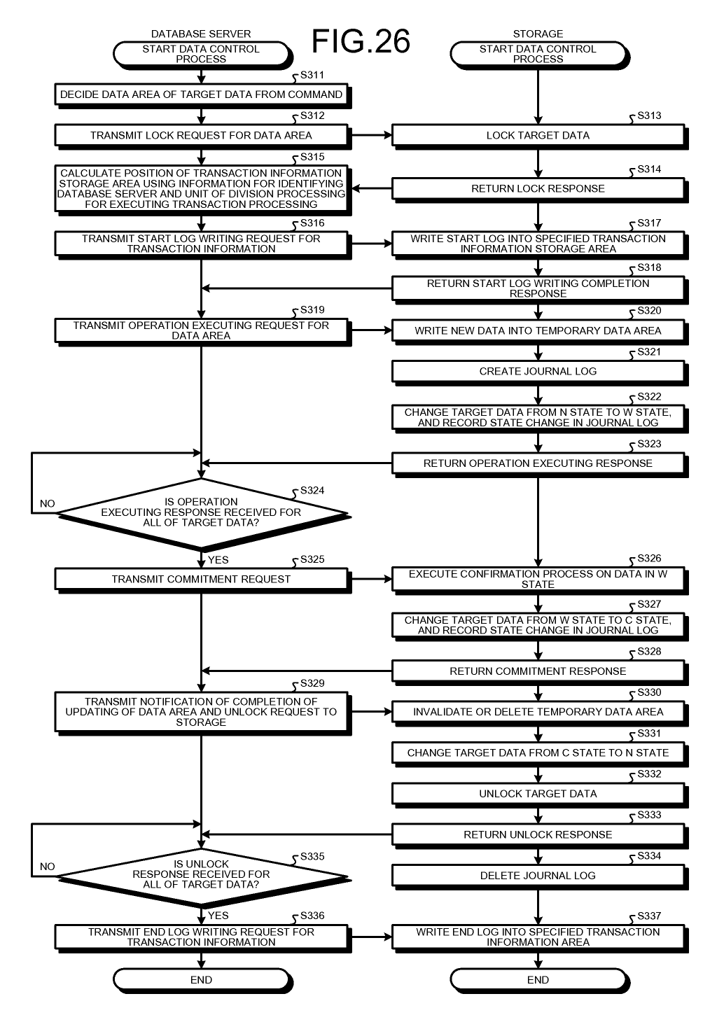

FIG. 26 is a flowchart of an example of a data control process in the database system according to the fourth embodiment. FIG. 26 represents operations in the database server 20 and the storage 30. First, the user transmits a command (data control request) for an operation of writing, updating, or deleting data (record) from the database client 10 to the database server 20.

The transaction management unit 21 of the database server 20 decides all of data areas requiring writing, updating, or deletion, based on the received data control request (step S311). For example, when data to be written has database index information or the like, the data may be written, updated, or deleted in a plurality of data areas 31. In addition, when the data is large in size or the number of data in each table is to be managed or held in another data area 31, the data may be written into a plurality of data areas 31. In the case where a plurality of data areas 31 is updated as described above, it is necessary to prevent inconsistency among these data areas 31. Data consistency can be maintained by pre-deciding all of relevant data areas 31 and performing collectively updating or deleting operations. When a key is specified in a key-value database, a hashing operation is performed on the key, and the address of the target data is decided based on the execution result.

Next, the transaction management unit 21 of the database server 20 makes a lock request for all of the data areas requiring writing or updating (step S312). Upon receipt of the lock request, the transaction processing unit 33 of the storage 30 turns on the lock state of the target data (step S313). After that, the data state management unit 212 returns a lock response to the lock request to the database server 20 (step S314).

Then, the transaction management unit 21 of the database server 20 calculates the position of the transaction information storage area 36 using the information for identifying its own database server 20 and the unit of division of processing such as a thread or process for transaction processing (step S315). Then, the transaction management unit 21 transmits to the storage 30 a start log writing request for writing a start log at the calculated position of the transaction information storage area 36 (step S316). The start log writing request includes the storage positions of all of data requiring writing, updating, or deletion as well as the “start log” as process type.

Upon receipt of the start log writing request, the transaction processing unit 33 of the storage 30 writes the start log at the specified position of the transaction information storage area 36 (step S317). The start log constitutes transaction information. Upon completion of writing of the start log, the transaction processing unit 33 returns a writing completion response to the start log writing request to the database server 20 (step S318).

After that, the transaction management unit 21 of the database server 20 transmits an operation executing request for writing, updating, or deleting of each of the data areas 31 to the storage 30 (step S319). The operation executing request includes the position of target data to be processed and data to be newly written.

Upon receipt of the operation executing request, the transaction processing unit 33 of the storage 30 writes the new data included in the operation executing request into the temporary data area 32 (step S320). At that time, the data written into the temporary data area 32 is connected to some of the target data. There is no need to connect target data to any target sector in the mode as in the second embodiment in which the storage 30 is not provided with the temporary data area 32 and the version of data to be written is controlled by metadata. Upon completion of the writing of the new data into the temporary data area 32, the transaction processing unit 33 creates a journal log corresponding to the target data in the journal log storage area 34 (step S321). One journal log may be created for each target data or may be created for a plurality of target data. In the latter case, the target data is written into the journal logs together with information for determining the target data, for example, the storage position of the target data. After that, the transaction processing unit 33 changes the state of the target data from the N state to the W state, and records the change in the writing state in the journal log in the journal log storage area 34 (step S322).

After that, the transaction processing unit 33 returns an operation completion response to the operation executing request to the database server 20 (step S323). The operation completion response may include the writing state of the target data. Upon receipt of the operation completion response, the transaction management unit 21 of the database server 20 determines whether the operation completion response has been received for all of the target data in the transaction processing (step S324). This determination is made depending on whether the operation executing response has been received indicating that all of the target data has been changed to the W state, for example. When all of the target data have not been changed to the W state (step S324: No), the transaction management unit 21 waits until all of the target data have been turned into the W state.

When all of the target data have been turned into the W state (step S324: Yes), the transaction management unit 21 of the database server 20 transmits a commitment request to each of the data areas 31 of the storages 30 (step S325). Upon receipt of the commitment request, the transaction processing unit 33 of the storage 30 executes a confirmation process for the data in the W state (step S326). This process is the same as the process described above in relation to the first embodiment at step S24 of FIG. 6.

The transaction processing unit 33 of the storage 30 also changes the W state to the C state and records the change in the state of the target data in the journal log (step S327). After that, the transaction management unit 21 returns a commitment response to the commitment request (step S328).

Then, the transaction management unit 21 of the database server 20 transmits a notification of completion of the updating of the data areas 31 and an unlock request to the storage 30 (step S329). Upon receipt of the notification of completion of the updating and the unlock request, the transaction processing unit 33 of the storage 30 invalidates or deletes the data in the temporary data area 32 (step S330). This process is the same as the process described above in relation to the first embodiment at step S28 of FIG. 6.

The transaction processing unit 33 also updates the state of the target data from the C state to the N state (step S331) and unlocks the target data (step S332). In the unlock process, the transaction processing unit 33 returns an unlock response to the unlock request to the database server 20 (step S333). The transaction processing unit 33 further deletes the journal log for the target data in the journal log storage area 34 (step S334).

The transaction management unit 21 of the database server 20 determines whether the unlock response has been received for all of the target data (step S335). When the unlock response has not been received for all of the target data (step S335: No), the transaction management unit 21 waits for the unlock response for all of the target data.

When the unlock response has been received for all of the target data (step S335: Yes), the transaction management unit 21 of the database server 20 transmits an end log writing request to the storage 30 (step S336). Upon receipt of the end log writing request, the transaction processing unit 33 of the storage 30 writes the end log into the specified transaction information storage area 36 (step S337). Accordingly, the transaction processing in the database system is completed.

As described above in relation to the first embodiment, after normal power-off, there arises no problem at the next boot. Meanwhile, after abnormal power-off such as when power-off takes place in the course of transaction processing, a process for maintaining data consistency is executed. Next, a boot process at power-on will be described.

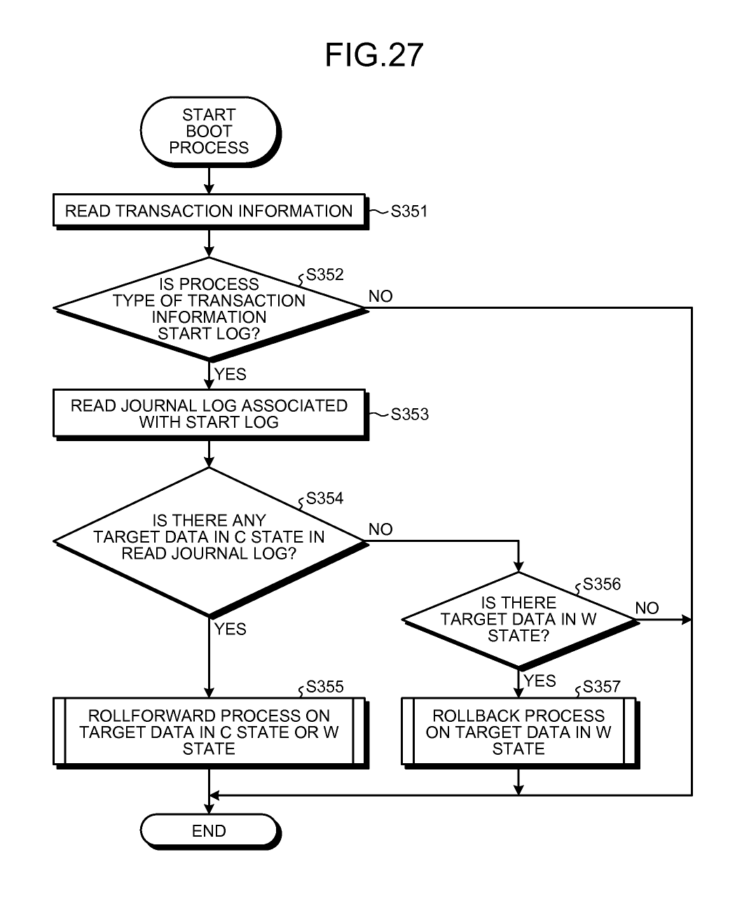

FIG. 27 is a flowchart of an example of the boot process at power-on of the database system according to the fourth embodiment. First, the restoration processing unit 213 of the database server 20 reads transaction information from the transaction information storage area 36 of the storage 30 (step S351). The transaction information storage area 36 is located at a pre-decided position for each combination of the database server 20 and a unit of division of processing by the database server 20. Thus, the restoration processing unit 213 reads transaction information from the transaction information storage area associated with each combination of the database server 20 and a unit of division of processing by the database server 20.

Then, the restoration processing unit 213 determines whether the process type of the transaction information is “start log” (step S352). When the process type is not “start log” (step S352: No), that is, when the process type is “end log,” this means that the transaction processing has been normally completed. That is, data consistency is maintained. Therefore, no process for restoration of the database is executed and the boot process is completed.

Meanwhile, when the process type is “start log” (step S352: Yes), this means that the previous power-off was an abnormal end with database consistency not maintained. That is, there is need to execute a restoration process for maintenance of data consistency in the database. Accordingly, the restoration processing unit 213 of the database server 20 reads from the storage 30 a journal log for the target data corresponding to the process type “start log” of the transaction information (step S353). In this case, for example, the restoration processing unit 213 acquires the storage position of the target data requiring the restoration process from the start log, and transmits to the storage 30 an instruction for reading the journal log for the target data. Otherwise, the transaction processing unit 33 of the storage 30 may read the journal log for the specified target data, and return the same to the database server 20.

The subsequent steps are the same as steps S54 to S57 in FIG. 7 and the steps in FIGS. 8 and 9, and brief descriptions thereof will be provided. The restoration processing unit 213 of the database server 20 determines whether there exists any target data in the C state in the journal log for the target data related to the target transaction processing (step S354). When there exists any target data in the C state (step S354: Yes), the restoration processing unit 213 executes a rollforward process on the target data in the C state or W state (step S355). The rollforward process is as described above with reference to FIG. 8. After that, the boot process at power-on is completed.

Meanwhile, when there exists no target data in the C state at step S354 (step S354: No), the restoration processing unit 213 then determines whether there exists any target data in the W state (step S356). When there exists no target data in the W state (step S356: No), the boot process is completed. Meanwhile, there exists any target data in the W state (step S356: Yes), the restoration processing unit 213 executes a rollback process (step S357). The rollback process is as described above with reference to FIG. 9. Accordingly, the boot process at power-on is completed.

The journal log is deleted at steps S334, S78, and S96 as described above. Alternatively, no journal log may be deleted from the journal log storage area 34 of the storage 30 but information indicating the completion of the transaction processing for the target data may be recorded in the journal log.

In the example described above, the storage 30 is provided with the temporary data area 32. Alternatively, as in the second embodiment, the storage 30 may not be provided with the temporary data area 32 but the version information of data to be written may be managed by metadata.

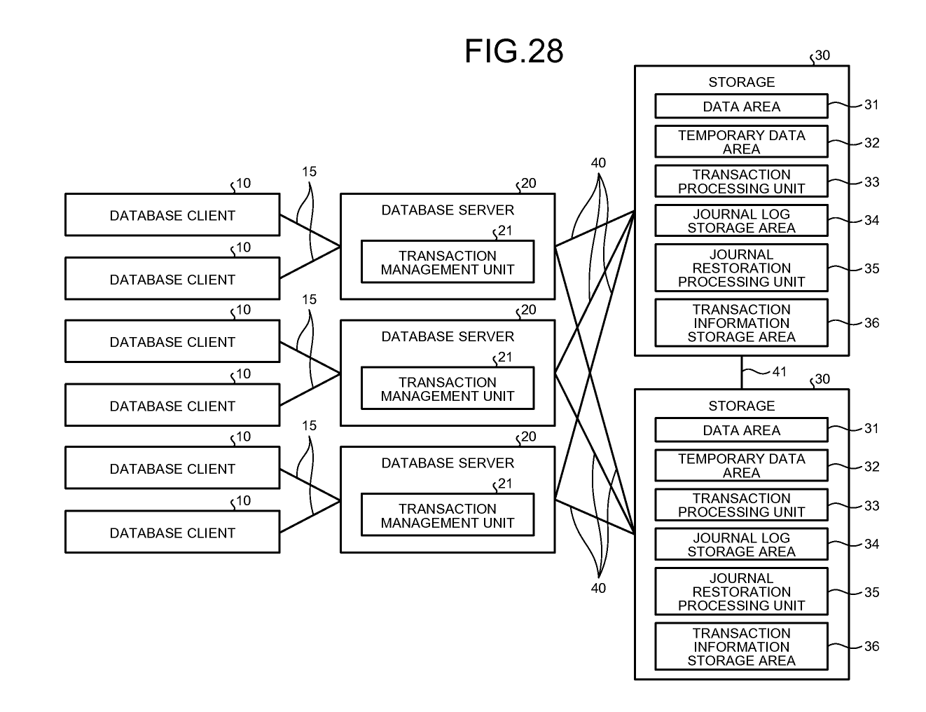

FIG. 21 illustrates the case with one storage 30, but the embodiment is not limited to this. FIG. 28 is a schematic block diagram of another example of the database system according to the fourth embodiment. In this example, two storages 30 are connected via a communication line 41 in the database system. Each of the storages 30 is configured in the same manner as described above in relation to the fourth embodiment. The storages 30 are also electrically connected to enable data transfer therebetween.

In the foregoing configuration, the storage 30 for writing, updating, or deleting target data and the storage 30 for recording transaction information for the target data may be different.

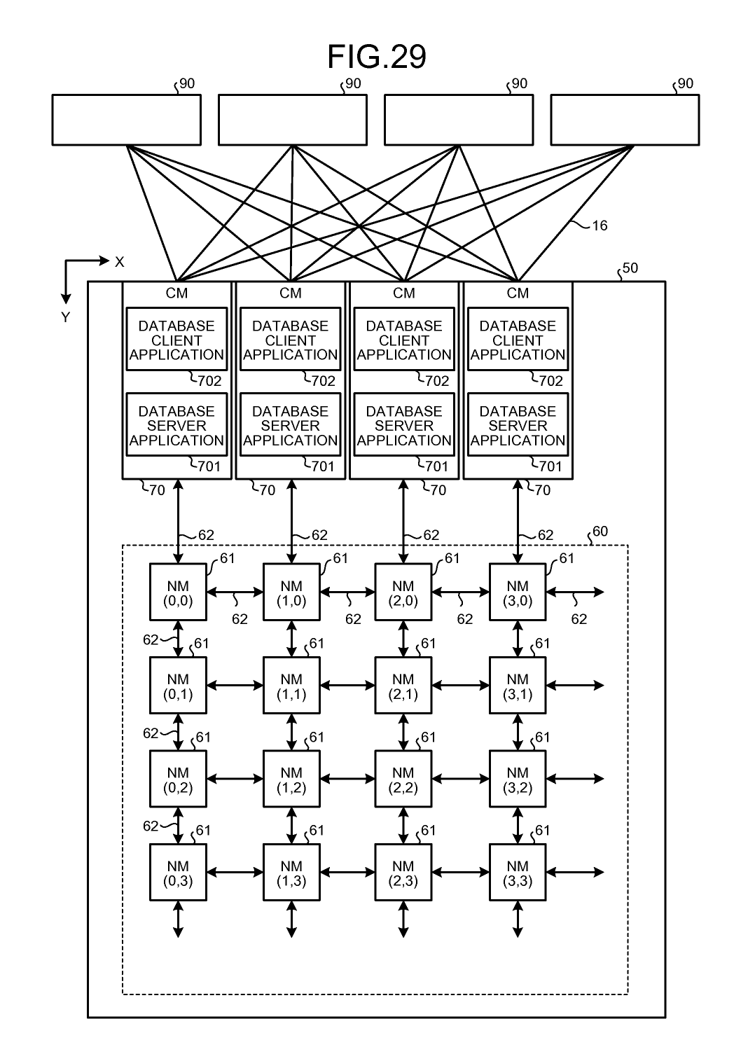

FIG. 29 is a schematic block diagram of another example of the database system according to the fourth embodiment. In this example, the database system is structured as in the third embodiment illustrated in FIG. 15. This database system is composed of the server storage unit 50. The server storage unit 50 includes a storage unit 60 and CMs 70 as described above. The storage unit 60 is configured such that a plurality of NMs 61 is interconnected in a mesh network. Each of the NMs 61 corresponds to the storage 30.

In this example, each of the CMs 70 is configured such that a database server application 701 and a database client application 702 are executed. Accordingly, each of the CM 70 functions as database server 20 and database client 10. The database client application 702 is a kind of an interface that has the function of accepting requests such as queries for insert, get, and set. The database server application 701 has the function of interpreting the requests from the database client application 702 and executing appropriate processing.

In this example, the CMs 70 are connected to information processing devices 90, for instance. However, the information processing devices 90 do not function as database clients but receive output of execution results from the CMs 70.

FIG. 29 illustrates the case where the CMs 70 functions as the database servers 20 and the database clients 10. Alternatively, as in the third embodiment illustrated in FIG. 15, the CMs 70 may function as the database servers 20 as in the fourth embodiment and may be connected to the database clients 10. Also in this case, the NMs 61 of the storage unit 60 correspond to the storages 30 as described above.

The configuration of the server storage unit 50 is the same as that described above in relation to the third embodiment, and descriptions thereof will be omitted. In addition, this example is the same as the third embodiment in that mirroring occurs in one NM 61 or between different NMs 61 through transmission of a packet, and the server storage unit 50 constitutes RAID, and thus descriptions thereof will be omitted.

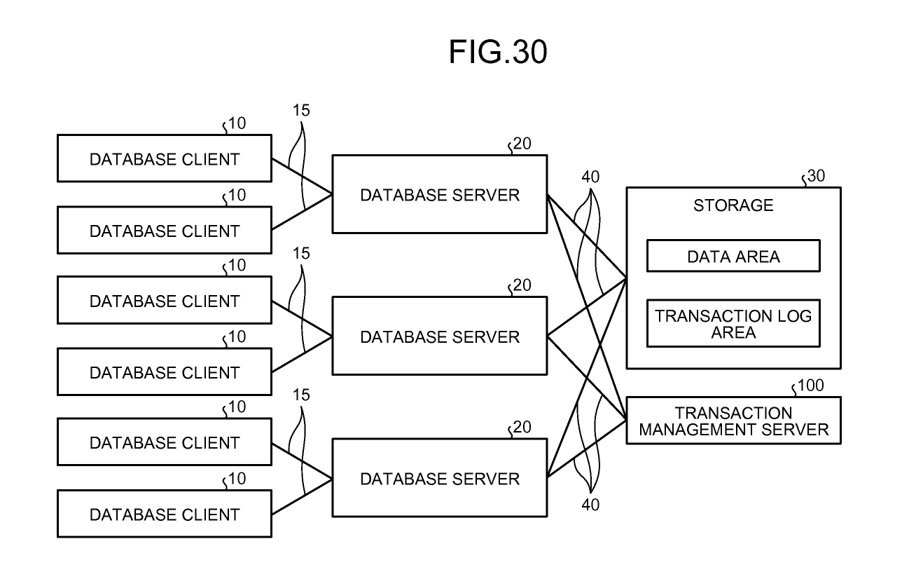

FIG. 30 is a schematic block diagram of an example of a general database system. The general database system is configured such that database clients 10, database servers 20, a storage 30, and a transaction management server 100 are connected together via a network. In this configuration, the storage 30 is provided with a data area for storing a database and a transaction log area for storing a transaction log. The transaction management server 100 manages transaction processing in the entire database system. The transaction management server 100 executes intensively processing for maintaining consistency of data to be stored in the storage 30. Therefore, a processing load concentrates on the transaction management server 100, and even if an increased number of database servers 20 is used, the transaction management server 100 causes a bottleneck. As a result, it is difficult to achieve performance improvement.

Meanwhile, in the fourth embodiment, the transaction processing unit 33 of the storage 30 records transaction information in the transaction information storage area 36 based on an instruction from the database server 20 and records changes in data writing state in the journal log storage area 34 in transaction processing. That is, the fourth embodiment makes it possible to shift the processes executed by the transaction management server 100 in the general database system to the storages 30, which eliminates the need for the transaction management server 100.

Further, in the fourth embodiment, transaction processing is executed mainly at the storage 30 side and there is no need for the transaction management server 100. This provides the advantage of avoiding a bottleneck in performance even though an increased number of database servers 20 is provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A database system in which a database server executing processing based on a data control request and a storage are connected via a communication line, wherein
the storage includes
a data area that stores a database,
a transaction information storage area that stores transaction information including a start log or an end log for transaction processing,
a journal log storage area that stores a journal log including writing state of the data to the storage based on the data control request, and
a first circuit that manages lock state and the writing state of target data in the storage, and records the journal log in the journal log storage area, and
the database server includes a second circuit that, upon receipt of the data control request, determines the transaction information storage area from a combination of the subject database server and a unit of division of processing executing the transaction processing, and writes the transaction information into the determined transaction information storage area.

2. The database system according to claim 1, wherein, at the start of the transaction processing, the second circuit overwrites the start log into the transaction information storage area, and at the end of the transaction process, the second circuit overwrites the end log into the transaction information storage area.

3. The database system according to claim 1, wherein the start log includes a process type indicative of the start of the transaction processing and storage position of target data in the transaction processing.

4. The database system according to claim 1, wherein the end log includes a process type indicative of the end of the transaction processing.

5. The database system according to claim 1, wherein a unit of division of processing by the database server is a thread or a process.

6. The database system according to claim 1, further comprising a database client that is connected to the database server via a network and transmits the data control request to the database.

7. The database system according to claim 1, wherein, when the target data is unlocked, the first circuit of the storage erases the journal log corresponding to the target data.

8. A database system in which a storage and a connection circuit are wired under a predetermined standard on a circuit board, the storage including node circuits configured to have non-volatile memory and a node controller controlling the non-volatile memory and to be connected together in a grid pattern, and the connection circuit being connectable to an external device, wherein
the connection circuit has a database server function, the database server function including a circuit that determines position of target data in transaction processing and performs an operation related to the target data based on a data control request, and records transaction information in a transaction information storage area, the transaction information including a start log or an end log for the transaction processing,
the non-volatile memory includes
a data area that stores a database, and
a journal log storage area that stores a journal log for use in a restoration process of the database system,
the node controller performs a writing process temporarily writing data to be written into the database and a commitment process confirming the temporarily written writing data, based on an instruction from the database server function, and records procedures of the processes in the journal log,
part of the non-volatile memory in the storage has the transaction information storage area that stores the transaction information, and
the circuit determines, upon reception of the data control request, the transaction information storage area from a combination of the subject database server and a unit of division of processing executing the transaction processing, and writes the transaction information into the determined transaction information storage area.

9. The database system according to claim 8, wherein, at the start of the transaction processing, the circuit overwrites the start log into the transaction information storage area, and at the end of the transaction process, the circuit overwrites the end log into the transaction information storage area.

10. The database system according to claim 8, wherein the start log includes a process type indicative of the start of the transaction processing and storage position of target data in the transaction processing.

11. The database system according to claim 8, wherein the end log includes a process type indicative of the end of the transaction processing.

12. The database system according to claim 8, wherein a unit of division of processing by the database server is a thread or a process.

13. The database system according to claim 8, wherein, when determining that the target data was not normally stored in the storage at the time of the previous power-off, the node controller uses the transaction information and the temporarily written writing data to maintain consistency of the data constituting the database.

14. The database system according to claim 13, wherein the circuit reads, when the transaction information is a start log, the journal log for the target data associated with the transaction processing in the start log from the storage, and executes, when there exists any of the target data in committed state in the read journal log, a rollforward process using the journal log on the target data related to the transaction processing.

15. The database system according to claim 14, wherein, when there exists no target data in committed state in the read journal log but there exists the target data in completely written state in the read journal log, the circuit deletes or invalidates the temporarily written writing data to execute the rollback process.

16. The database system according to claim 14, wherein, when there exists no target data in committed state and there exists no target data in completely written state in the read journal log, the circuit executes no process on the target data.

17. The database system according to claim 8, wherein the node controller receives a packet from one of the other node circuits or the connection circuit, and when the packet is addressed to the node circuit to the node controller belongs, performs an operation on the database based on contents of the packet, and when the packet is not addressed to the node circuit to the node controller belongs, transfers the packet to the other adjacent node circuit.

18. The database system according to claim 8, wherein the connection circuit further includes a database client function that accepts a data control request from a user.

19. The database system according to claim 8, wherein the external device is a database client that accepts a data control request from a user, the database client being connected to the connection circuit via a network.

20. A database system including a database server and a storage storing a database, wherein
the storage includes
a first log storage area that stores a first log indicative of start or end of transaction processing, and
a second log area that stores writing state of data, and
the database server writes the first log into the first log storage area determined by a unit of division of processing for which a data control request is accepted.
